(19) United States
(12) Patent Application Publication
(10) Pub. No.: US 2024/0032486 A1
(43) Pub. Date: Feb. 1, 2024

(54) DEPLOYABLE FIELD PROTECTION SYSTEM AND METHOD OF USING THE SAME

(71) Applicant: CREAVAL INC., Repentigny (CA)

(72) Inventor: Guy Charron, Repentigny (CA)

(21) Appl. No.: 18/266,221

(22) PCT Filed: Dec. 9, 2021
(86) PCT No.: PCT/CA2021/051766

§ 371 Date: Jun. 8, 2023

Related U.S. Application Data
(60) Provisional application No. 63/123,038, filed on Dec. 9, 2020.
(60) Provisional application No. 63/260,747, filed on Aug. 31, 2021.

(51) Int. Cl. A01G 13/02; F16B 2/22

(52) U.S. Cl. CPC A01G 13/0206; F16B 2/22

(57) ABSTRACT

The present disclosure concerns different embodiments of field protection systems to form a protection over a field to be protected, comprising a flexible membrane assembly comprising a flexible membrane and a plurality of flexible membrane-deploying clips mounted thereto or a plurality of foldable frame members at least partially engageable with a field-facing surface of the flexible membrane, the foldable frame members comprising first and second opposed ground-securing end portions. It also concerns corresponding methods for forming a protection over a field.

### PRIOR APPLICATION

The present application claims priority from U.S. provisional patent application No. 63/123,038, filed on Dec. 9, 2020, and entitled “DEPLOYABLE field PROTECTION SYSTEM AND METHOD OF USING THE SAME”, and from U.S. provisional patent application No. 63/260,747, filed on Aug. 31, 2021, and entitled “DEPLOYABLE field PROTECTION SYSTEM AND METHOD OF USING THE SAME”. The disclosures of the two US provisional patent applications are hereby incorporated by reference in their entirety.

### TECHNICAL FIELD

The technical field relates to field protection systems, and more particularly to deployable field protection systems and to corresponding methods for forming and maintaining a protective canopy over a field.

### BACKGROUND

Crops or bushes, for instance in the agriculture field, often need to be protected by a net or any other suitable flexible membrane, from deterioration by birds, insects, mosquitos, and the like. Moreover, to increase the fostering of the crops, it might be needed to cover the field with a protective film so as to form a greenhouse. It is also needed to protect a field area from weather conditions, for instance to cover the field area during winter or against heavy rain, hail, frost, snow and the like. However, deployment of such flexible membranes over an area, for instance over bushes or crops, might be difficult and once deployed over the area, the stability of the installation might be unsatisfactory so that the protection of the area might not be efficient.

In view of the above, there is a need for a deployable field protection system which would be able to overcome or at least minimize some of the above-discussed prior art concerns.

### BRIEF SUMMARY

It is therefore an aim of the present invention to address the above-mentioned issues.

According to a general aspect, there is provided membrane-deploying clip for a membrane assembly of a field protection system, the membrane-deploying clip comprising: a clip body comprising: a membrane-mounting portion; and a wire-sliding portion with a wire-receiving slot formed therein and extending along a clip longitudinal direction; and a mobile locking member mounted to the clip body and configurable into a wire-engaging configuration wherein a guide wire is insertable into the wire-receiving slot, and a wire-sliding configuration wherein, considered in a direction transversal to the clip longitudinal direction, the mobile locking member substantially closes the wire-receiving slot to maintain the guide wire into the wire-receiving slot while sliding therein. According to another general aspect, there is provided a guide wire-mounting post head for a field protection system, comprising: a post head body mountable to a post to extend above a field to be protected and having a wire-mounting slot formed therein and extending along a head longitudinal direction; a mobile latch mounted to the post head body and configurable into an open configuration wherein a guide wire is insertable into the wire-mounting slot, and a closed configuration wherein, considered in a direction transversal to the head longitudinal direction, the mobile latch substantially closes the wire-mounting slot to maintain the guide wire into the wire-mounting slot. According to another general aspect, there is provided field protection system to form a protective canopy over a field, comprising: a membrane assembly comprising a membrane and a plurality of membrane-deploying clips according to the present disclosure mounted to or formed integral with the membrane; a plurality of guide wire-mounting post heads according to the present disclosure mountable to a plurality of posts to extend above the field to be protected; and a guide wire at least partially receivable into the wire-mounting slots of the plurality of guide wire-mounting post heads to extend above the field to be protected. According to another general aspect of the disclosure, there is provided a method for forming a protective canopy over a field, the method comprising: arranging a plurality of guide wire-mounting post heads above said field, each of said plurality of guide wire-mounting post heads having a wire-mounting slot formed therein; inserting a guide wire into the wire-mounting slots of the plurality of guide wire-mounting post heads; securing first and second end portions of the guide wire to a ground surface surrounding said field; providing a membrane assembly comprising a membrane and a plurality of membrane-deploying clips mounted thereto or formed integral therewith, each of said plurality of membrane-deploying clips having a wire-receiving slot formed therein; engaging the guide wire with the wire-receiving slots of the plurality of membrane-deploying clips at the first end portion of the guide wire; and sliding the plurality of membrane-deploying clips along the guide wire towards the second end portion of the guide wire to deploy the membrane assembly over said field to form the protective canopy.

According to another general aspect of the disclosure, there is provided a field protection system to form a protection over a field, comprising: a membrane assembly comprising a membrane having a field-facing surface; and a plurality of foldable frame members at least partially engaged with the field-facing surface of the membrane, each of said plurality of foldable frame members comprising first and second frame legs each comprising a ground-securing end portion and an opposed connecting portion, the first and second frame legs being connected to each other via their respective connecting portions; wherein each of said plurality of foldable frame members is configurable into a storage configuration wherein the first and second frame legs are substantially aligned with each other, and into a protection configuration, wherein the first and second frame legs are inclined with respect with each other with the connecting portions thereof forming an apex of the corresponding foldable frame member. According to another general aspect, there is provided a method for forming a protection over a field, the method comprising: arranging a protection-supporting cable above said field; providing a field protection system comprising a membrane assembly and a plurality of foldable frame members engaged with a field-facing surface of the membrane assembly; deploying the membrane assembly over the protection-supporting cable; and folding the plurality of foldable frame members for first and second opposed ground-securing end portions thereof to be engaged with a ground surface surrounding said field. According to a general aspect, there is provided a flexible membrane-deploying clip for a flexible membrane assembly of a field protection system, comprising: a clip body comprising: a membrane-mounting portion; and a wire-sliding portion with a wire-receiving slot formed therein; and a mobile locking member mounted, for instance pivotally, to the clip body and configurable into a wire-engaging configuration wherein a guide wire is insertable into the wire-receiving slot, and a wire-sliding configuration wherein the mobile locking member maintains the guide wire into the wire-receiving slot. According to another general aspect, there is provided a guide wire-mounting post head for a field protection system, comprising: a post head body mountable to a post to extend above a field to be protected and having a wire-mounting slot formed therein; with or without a pivoting latch mounted, for instance pivotally, to the post head body and configurable into an open configuration wherein a guide wire is insertable into the wire-mounting slot, and a closed configuration wherein the pivoting latch maintains the guide wire into the wire-mounting slot. For instance, the latch is pivotally mounted to the post head body. According to another general aspect, there is provided a field protection system to form a canopy over a field to be protected, comprising: a flexible membrane assembly comprising a flexible membrane and a plurality of flexible membrane-deploying clips according to the present disclosure mounted to the flexible membrane; a plurality of guide wire-mounting post heads according to the present disclosure mountable to a plurality of posts to extend above the field to be protected; and a guide wire at least partially receivable in the wire-mounting slots of the plurality of guide wire-mounting post heads to extend above the field to be protected. For instance, the flexible membrane-deploying clips are mounted to a longitudinal border of the flexible membrane, or to a body thereof. According to another general aspect, there is provided a method for forming a protective canopy over an area, the method comprising: arranging a plurality of guide wire-mounting post heads above said area, each of said guide wire-mounting post heads having a wire-mounting slot formed therein; inserting a guide wire in the wire-mounting slots; securing first and second end portions of the guide wire to a ground surface surrounding said area; providing a flexible membrane assembly comprising a flexible membrane and a plurality of flexible membrane-deploying clips mounted thereto (for instance to a longitudinal border or within the core of the flexible membrane); engaging the plurality of membrane-deploying clips with the guide wire at one of the first and second end portions thereof; and sliding the plurality of membrane-deploying clips along the guide wire towards the other of the first and second end portions thereof to deploy the flexible membrane assembly over said area to form the protective canopy. According to another general aspect, there is provided a field protection system to form a protection over a field, comprising: a flexible membrane assembly comprising a flexible membrane having a field-facing surface and a plurality of frame-receiving hems secured to or formed integral with the field-facing surface of the flexible membrane; a plurality of foldable frame members at least partially engageable with the frame-receiving hems and comprising first and second opposed ground-securing end portions. According to another general aspect, there is provided a method for forming a protection over an area, the method comprising: arranging a protection-supporting cable above said area; providing a field protection system comprising a flexible membrane assembly and a plurality of foldable frame members engaged with a field-facing surface of the flexible membrane assembly; deploying the flexible membrane assembly over the protection-supporting cable; and folding the plurality of foldable frame members for first and second opposed ground-securing end portions thereof to be engaged with a ground surface surrounding said area.

### BRIEF DESCRIPTION OF THE DRAWINGS

FIG. 1 is a side elevation view of a field protection system in accordance with an embodiment, the field protection system comprising a plurality of post heads, a guiding elongate element at least partially received in wire-guiding slots of the plurality of post heads provided over a field to be protected, a deployable flexible membrane assembly configured in an undeployed configuration and a membrane-deploying system;

FIG. 2 is a top perspective view, partially exploded, of one of the post heads of FIG. 1 with the guiding elongate element partially received in the wire-guiding slot thereof;

FIG. 3 is a top perspective view of one of the post heads of FIG. 1 with membrane-deploying clips sliding along the guiding elongate element towards the post head;

FIG. 4A is a top perspective view of one of the membrane-deploying clips of FIG. 3 in a wire-sliding configuration;

FIG. 4B is a bottom perspective view of the membrane-deploying clip of FIG. 4A;

FIG. 5A is a top perspective view, exploded, of the membrane-deploying clip of FIG. 4 in a wire-engaging configuration;

FIG. 5B is a rear elevational view of the membrane-deploying clip of FIG. 5A;

FIG. 6 is a front elevation view of one of the post heads of FIG. 1 with the membrane-deploying clips arranged in the wire-guiding slot thereof;

FIG. 7 is a top perspective view of the post head and the membrane-deploying clips of FIG. 3, a pivoting latch of the post head being configured in a partially open configuration, a first membrane-deploying clip being at an inlet of the wire-guiding slot;

FIG. 8 is a top perspective view of the post head and the membrane-deploying clips of FIG. 7, the first membrane-deploying clip being at an outlet of the wire-guiding slot, the pivoting latch of the post head being configured in a closed configuration and a second membrane-deploying clip being proximate the inlet of the wire-guiding slot;

FIG. 9 is a top perspective view of a plurality of membrane-deploying clips mounted to a clip-mounting strip of the flexible membrane assembly of FIG. 1;

FIG. 10 is a top perspective view of an installation assembly with two clip-guiding channels formed therein, membrane-deploying clips of FIG. 4A being arranged proximate inlets of the clip-guiding channels;

FIG. 11 is a top elevation view of the installation assembly of FIG. 10;

FIG. 12 is a top perspective view of a toothed pulley of the membrane-deploying system of FIG. 1 with membrane-deploying clips arranged between adjacent teeth thereof;

FIG. 13 is a side elevation view of the toothed pulley of FIG. 12;

FIG. 14 is a side perspective view of a membrane-deploying system in accordance with another embodiment, the membrane-deploying system comprising the installation assembly of FIG. 10;

FIG. 15A is a bottom perspective view of a membrane-deploying clip in accordance with another embodiment, the membrane-deploying clip being the wire-sliding configuration;

FIG. 15B is a rear elevational view of the membrane-deploying clip of FIG. 15A;

FIG. 15C is a top perspective view of the membrane-deploying clip of FIG. 15A, at an inlet of a post head in accordance with another embodiment;

FIG. 16 is a front elevational view of a field protection system in accordance with another embodiment, the field protection system comprising a flexible membrane assembly and a plurality of foldable frame members engaged with a field-facing surface of the flexible membrane assembly;

FIG. 17 is a front elevational view of the field protection system of FIG. 16, the flexible membrane assembly being supported on a protection-supporting cable, the foldable frame members being engaged with a ground surface;

FIG. 18 is a bottom elevational view of the field protection system of FIG. 16;

FIG. 19 is a front elevational view of a field protection system in accordance with another embodiment, the foldable frame members comprising first and second cable-engaging hooks;

FIG. 20 is a front elevational view of the field protection system of FIG. 19, the flexible membrane assembly being supported on a protection-supporting cable and the cable-engaging hooks of the foldable frame members being engaged with first and second bottom cables;

FIG. 21 is a bottom elevational view of a flexible membrane assembly in accordance with an embodiment;

FIG. 22 is an enlarged bottom elevational view of the flexible membrane assembly of FIG. 21, a foldable frame member being engaged therewith;

FIG. 23 is a front elevational view of a field protection system in accordance with another embodiment, the foldable frame members comprising first and second cable-engaging hooks in accordance with another embodiment;

FIG. 24 is a front elevational view of the field protection system of FIG. 23, the flexible membrane assembly being supported on a protection-supporting cable and the cable-engaging hooks of the foldable frame members being engaged with first and second bottom cables;

FIG. 25 is a front elevational view of a field protection system in accordance with another embodiment, the foldable frame members comprising first and second cable-engaging hooks in accordance with another embodiment;

FIG. 26 is a front elevational view of a field protection system in accordance with another embodiment, the foldable frame members comprising first and second cable-engaging hooks in accordance with another embodiment;

FIG. 27 is an enlarged front elevational view of a field protection system in accordance with another embodiment, the flexible membrane assembly comprising a deployable pole-mounting base assembly configured in a locked retracted configuration;

FIG. 28 is an enlarged front elevational view of the field protection system of FIG. 27, the deployable pole-mounting base assembly being configured in an unlocked deployed retracted configuration;

FIG. 29 is an enlarged front elevational view of the field protection system of FIG. 27, the deployable pole-mounting base assembly being in a locked deployed configuration, a foldable frame member being mounted to the deployable base assembly;

FIG. 30 is a front perspective view of a deployable pole-mounting base assembly in accordance with another embodiment, the deployable base assembly being configured in a locked deployed configuration;

FIG. 31 is a front perspective view of the deployable base assembly of FIG. 30, configured in an unlocked deployed configuration;

FIG. 32 is a top elevational view of a fluid-receiving ballast system in accordance with an embodiment;

FIG. 33 is a top elevational view of the fluid-receiving ballast system of FIG. 32 in an unfolded state;

FIG. 34 is a top elevational view of a flexible membrane assembly in accordance with another embodiment, comprising a flexible membrane and fluid-receiving ballast systems of FIG. 32 secured to longitudinal borders of the flexible membrane;

FIG. 35 is a top perspective view of a field area covered by a field protection system in accordance with an embodiment;

FIG. 36 is a side perspective view of a field area covered by a field protection system in accordance with another embodiment; and

FIG. 37 is a top perspective view of a field area covered by a field protection system in accordance with another embodiment.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only. Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the field protection system and are not necessarily to scale. To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value. In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments. It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure. Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included. The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

Field Protection Systems with Membrane-Deploying Clips

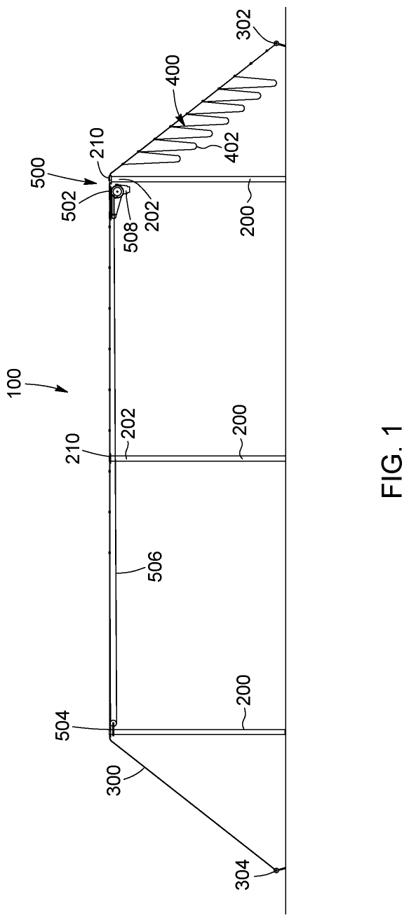

Referring now to the drawings, and more particularly to FIG. 1, there is shown a field protection system 100 (or bush protection system 100 or protective canopy system 100 or deployable crop protection system 100 or crop roofing system 100) in accordance with an embodiment.

### Field Protection System

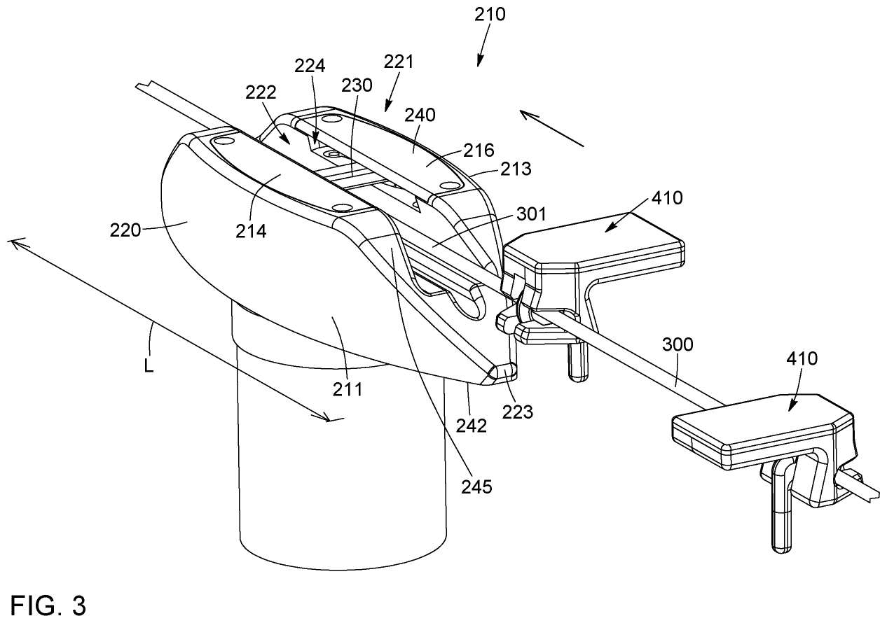

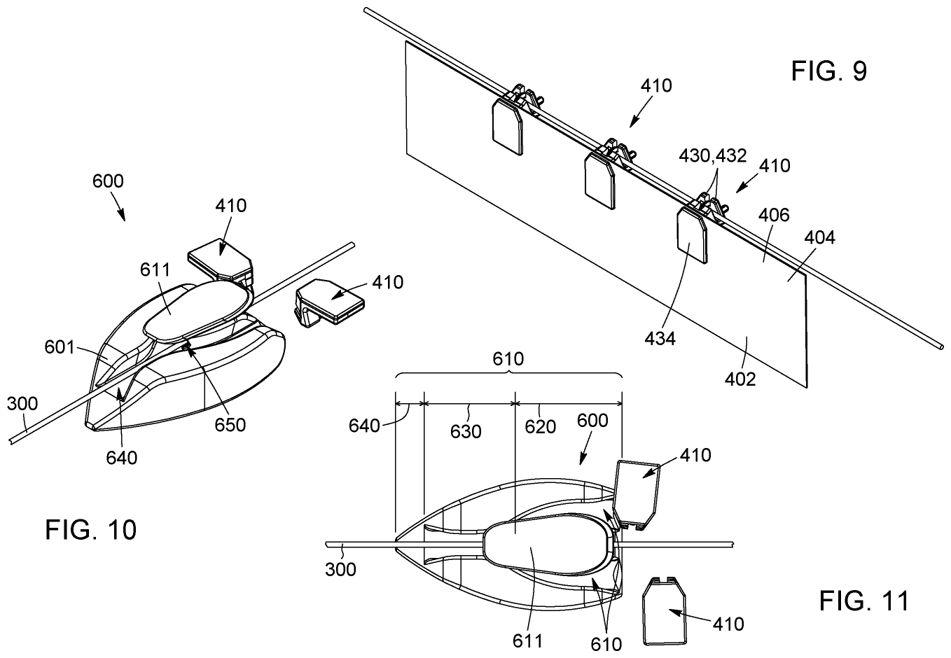

In the embodiment shown, the field protection system 100 comprises a plurality of vertical posts 200 arranged along the field or area to be protected, with post heads 210 mounted at an upper portion 202 thereof. The bush protection system 100 further comprises a guiding elongate element 300 (or guide wire 300) with first and second opposed end portions 302, 304 secured to a ground surface, in the vicinity of the area to be protected (for instance to the ground surface surrounding the area or field to be protected). The bush protection system 100 also comprises a deployable flexible membrane assembly 400 (or deployable bush-covering assembly 400 or deployable net-type protective cover assembly 400) configured in FIG. 1 in an undeployed configuration. The deployable flexible membrane assembly 400 comprises a flexible membrane 402 with a plurality of membrane-deploying clips 410 (FIG. 3) mounted thereto (for instance to a longitudinal border 404 thereof—FIG. 9 but the clips could be mounted to any other part of the flexible membrane, for instance to a central portion thereof) and engageable with the guiding elongate element 300 and slidable along the guiding elongate element 300. For instance, the flexible membrane 402 is at least partially made of net, mosquito net, plastic films, fabrics, canvas, geotextile membrane or any other suitable flexible material. When configured in the undeployed configuration as represented in FIG. 1, the membrane-deploying clips 410 are arranged at the first end portion 302 of the guiding elongate element 300. For instance and without being limitative, the bush protection system 100 (or area protection system 100) is configured to protect the area from birds, insects, mosquitos and the like as well as for weather condition like frost, hail, heavy rain, snow and the like. It could also be used to form a greenhouse, for instance when the flexible membrane assembly 400 is at least partially formed of a plastic film. In the embodiment shown, the bush protection system 100 comprises a motorized membrane-deploying system 500, but the deployable flexible membrane assembly 400 could also be deployed (i.e. be configured into a deployed configuration) in a manual manner. As detailed below, the post heads 210 are shaped and dimensioned to at least partially receive the guiding elongate element 300 so that the guiding elongate element 300 extends above the area to be protected and/or covered by the flexible membrane assembly 400. Moreover, as detailed below, the post heads 210 and the membrane-deploying clips 410 are configured to cooperate together to allow a sliding of at least some of the membrane-deploying clips 410 along the guiding elongate element 300 toward the second end portion 304 thereof, in order to deploy the flexible membrane 402 over the area to be protected (i.e. to configure the flexible membrane assembly 400 in the deployed configuration, i.e. to form a protective canopy of the area or crop field to be protected). The different components of the bush protection system 100 will now be described in more details.

Guide Wire-Mounting Post Head

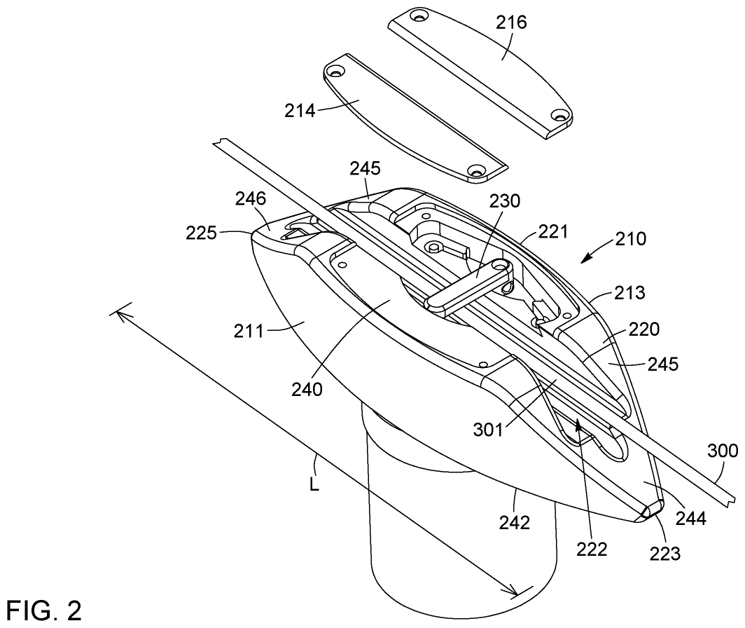

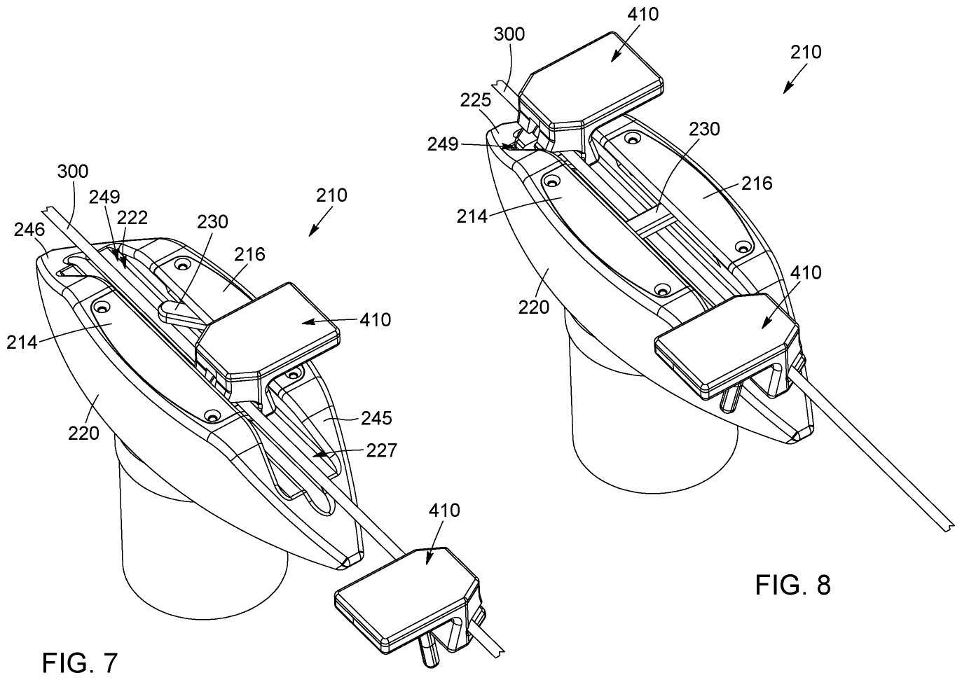

In the embodiment shown, the guide wire-mounting post heads 210 have a similar shape, so that the following description of one of the post heads 210 will apply to any of them. In the embodiment shown, as represented for instance in FIGS. 2, 3 and 6, the guide wire-mounting post head 210 comprises a post head body 220 mountable to one of the vertical posts 200 (for instance at the upper portion 202 thereof) and having a wire-mounting slot 222 formed therein. The post head 210 further comprises a mobile latch 230 (for instance a pivoting latch) mounted to the post head body 220 (for instance pivotally mounted thereto, for instance about a substantially vertical pivoting axis) and configurable into an open configuration (FIG. 7) wherein the guide wire 300 is insertable into the wire-mounting slot 222, and a closed configuration (FIGS. 2 and 3) wherein the pivoting latch 230 maintains the guide wire 300 into the wire-mounting slot 222. The disclosure is not limited to a pivoting latch, and the post head 210 could comprise any other type of guide wire-retaining system.

As best shown in FIGS. 2 and 3, the post head body 220 defines a longitudinal direction L (or head longitudinal direction) substantially parallel to a portion 301 of the guide wire 300 received in the wire-mounting slot 220 and has first and second longitudinal sides 240, 242 (or a flexible membrane-facing side 240 and an opposed ground-facing side 242) and first and second end portions 244, 246 (or inlet and outlet portions 244, 246) extending between the first and second longitudinal sides 240, 242 (i.e. between the flexible membrane-facing side 240 and the ground-facing side 242) and at least partially forming opposed longitudinal end portions of the post head body. The longitudinal wire-guiding slot 222 opens into the first longitudinal side 240 (i.e. into the flexible membrane-facing side 240) and, considered along the head longitudinal direction L, into the first and second end portions 244, 246. In other words, considered in a plane substantially perpendicular to the head longitudinal direction L, the post head body 220 is substantially U-shape (or C-shape). The post head body 220 could be arranged so that, once mounted to the vertical post, the wire-mounting slot opens towards a side (i.e. to be accessible from a side thereof), a top portion (i.e. to be accessible from above the guide wire-mounting post head, as in the embodiment shown) or a bottom portion (i.e. to be accessible from below the guide wire-mounting post head) of the post head body. For instance, the second longitudinal side 242 is securable to the vertical post 200 (for instance at the upper portion 202 thereof). Considered in a plane substantially perpendicular to the head longitudinal direction L, as best shown in FIG. 6, a cross-section of the wire-mounting slot 222 decreases towards the flexible membrane-facing side 240. For instance, in the embodiment shown, the cross-section of the wire-mounting slot 222 is substantially trapezoidal. As mentioned above, the pivoting latch 230 is mounted (for instance pivotally) to the post head body 220 (for instance to the flexible membrane-facing side 240 thereof) and is configurable into the closed position, wherein the pivoting latch 230 at least partially closes a guide wire-receiving opening 224 formed by the wire-guiding slot 222 in the flexible membrane-facing side 240 (FIG. 2). The post head 210 might further comprise one or more biasing members biasing the pivoting latch 230 towards the closed position to maintain the guiding elongate element 300 within the wire-mounting slot 222 (i.e. to limit the risk that the guiding elongate element 300 be accidentally removed from the wire-mounting slot 222 upon displacement thereof in a direction transversal to the head longitudinal direction L with respect to the post head 210).

In the embodiment shown, the post head 210 further comprises latch-maintaining members 214, 216 (or first and second latch-maintaining hoods 241, 246) mountable to the flexible membrane-facing side 240 and contributing to pivotally mount the pivoting latch 230 to the post head body 220. In the embodiment shown, considered in a plane substantially perpendicular to the head longitudinal direction L, the pivoting latch 230 is at least partially sandwiched between the latch-maintaining members 214, 216 and the post head body 220. The latch-maintaining members 214, 216 are shaped and dimensioned not to substantially cover the guide wire-receiving opening 224 formed by the wire-guiding slot 222 in the flexible membrane-facing side 240. In the embodiment shown, at least one of the first and second end portions 244, 246 of the post head body 220 comprises a clip-actuating slope 245 (or clip-actuating ramp 245). As best shown in FIG. 2, the clip-actuating slope 245 is shaped and dimensioned so that, considered in a plane containing the head longitudinal direction L and substantially transversal to at least one of the first and second longitudinal sides 240, 242 (or upper and lower longitudinal sides 240, 242), a cross-section of the first end portion 244 increases towards the pivoting latch 230. In other words, the first and second longitudinal sides 240, 242 converge toward each other at at least one of the first and second end portions 244, 246. In yet other words, considered in a plane substantially perpendicular to the lower longitudinal side 242 (i.e. in a substantially vertical plane when the lower longitudinal side 242 is mounted to a substantially horizontal surface), a cross-section of a central portion 221 of the post head body 220 is greater than a cross-section of first and second longitudinal extremities 223, 225 thereof. In other words, considered in a plane substantially perpendicular to one of the upper and lower longitudinal sides, a cross-section of at least one of the first and second end portions 244, 246 increases from the corresponding extremity 223, 225 towards the central portion 221 of the post head body 220. In yet other words, considered in a plane substantially perpendicular to the second longitudinal side 242 (i.e. in a substantially vertical plane when the second longitudinal side 242 is mounted to a substantially horizontal surface), the post head body 220 is substantially tapered towards the first and second extremities 223, 225 thereof. In the embodiment shown, the post head body 220 has a first plane of symmetry containing the head longitudinal direction L and substantially transversal (for instance substantially perpendicular) to the upper and lower longitudinal sides 240, 242 (i.e. a substantially vertical first plane of symmetry). In the embodiment shown, the post head body 220 has a second plane of symmetry substantially perpendicular to the first plane of symmetry (i.e. substantially perpendicular to the head longitudinal direction L and the upper and lower longitudinal sides 240, 242). In the embodiment shown, the second plane of symmetry is also substantially vertical. It is thus understood that the guiding elongate element 300 (or guide wire 300) extends over the field to be protected by being secured to the ground surface at the first and second end portions 302, 304 thereof and by being at least partially contained or retained in the longitudinal wire-mounting slots 222 of the post heads 210. It is understood that when the pivoting latch 230 is configured into the closed position, the guiding elongate member 300 is maintained or retained into the wire-mounting slot 222 (i.e. is prevented from being removed therefrom upon displacement in a direction transversal to the head longitudinal direction L, for instance upon displacement in a substantially vertical direction). In the embodiment shown, the post head body 220 further comprises first and second longitudinal sides 211, 213 extending between the flexible membrane-facing side 240 and the ground-facing side 242, and from the first extremity to the second extremity. In the embodiment shown, the first and second longitudinal sides 211, 213 form a convexity opposed to the longitudinal guide wire-mounting slot 222. In other words, in the embodiment shown, the first and second longitudinal sides 211, 213 of the post head body 222 have a substantially curved profile. It is appreciated that the shape, the configuration of the post head, as well as the shape, the configuration and the relative arrangement of the post head body, the wire-mounting slot and the pivoting latch thereof, can vary from the embodiment shown.

Flexible Membrane-Deploying Clip

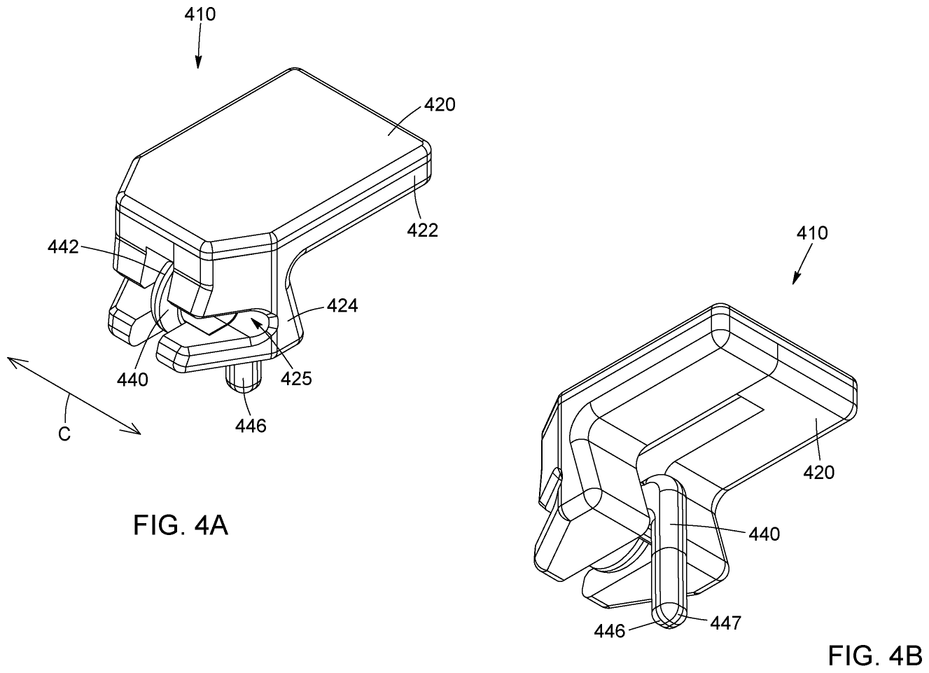

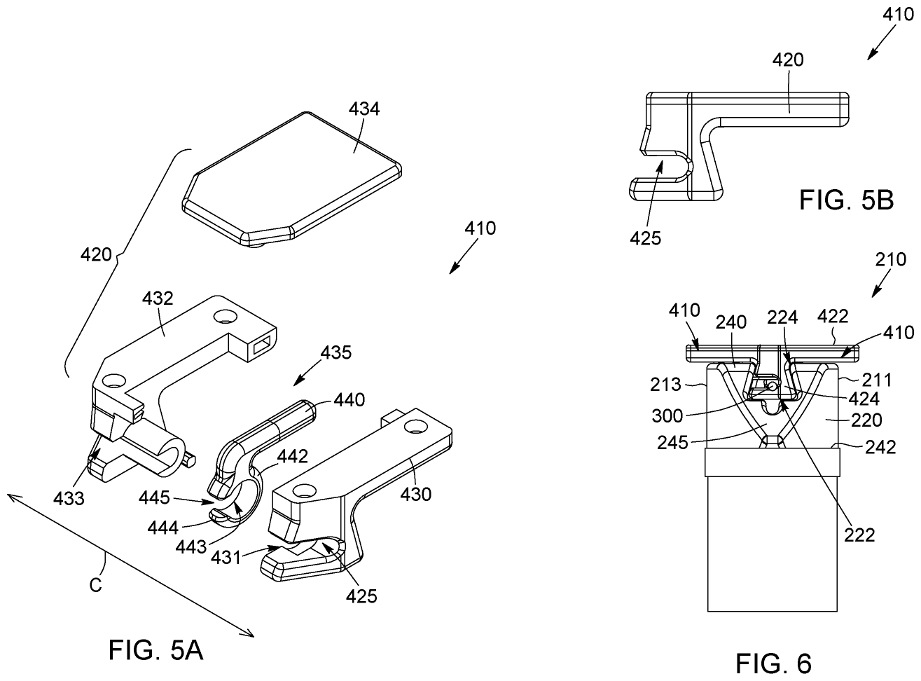

In the embodiment shown, the flexible membrane-deploying clips 410 (or membrane-deploying clips) have a similar shape, so that the following description of one of the flexible membrane-deploying clips 410 will apply to any of them. As best shown in FIGS. 4A to 5B, the flexible membrane-deploying clip 410 comprises a clip body 420 comprising a membrane-mounting portion 422 and a wire-sliding portion 424 with a wire-receiving slot 425 formed therein, the wire-receiving slot extending along a clip longitudinal direction C. The flexible membrane-deploying clip 410 further comprises a mobile locking member 440 mounted (for instance pivotally) to the clip body 420 and configurable into a wire-engaging configuration (FIGS. 5A and 5B) wherein the guide wire 300 (or guiding elongate element 300) is removably insertable into the wire-receiving slot 425 (i.e. wherein the membrane-deploying clip 410 can be removably engaged with the guiding elongate member 300), and a wire-sliding configuration (FIGS. 4A and 4B) wherein the mobile locking member 440 maintains the guide wire 300 into the wire-receiving slot 425 (i.e. wherein the membrane-deploying clip 410 is slidable along the guiding elongate member 300 without being removable therefrom, i.e. wherein the guiding elongate member 300 is prevented from being removed from the wire-receiving slot 425 in a direction transversal to the clip longitudinal direction C). In other words, in the wire-sliding configuration, considered in a direction transversal to the clip longitudinal direction C, the mobile locking member 440 substantially closes the wire-receiving slot 425 to maintain the guide wire 300 into the wire-receiving slot 425 while sliding therein.

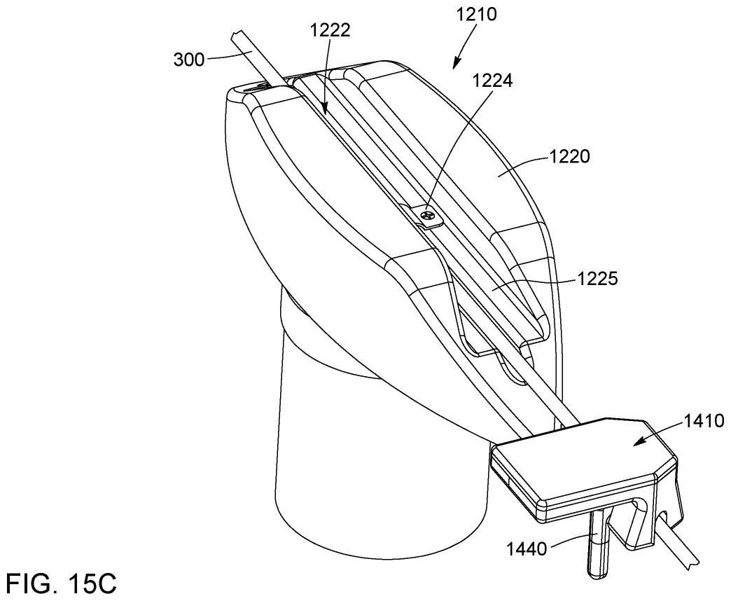

It is understood that the membrane-deploying clip 410 is shaped and dimensioned to slide along the guiding elongate element 300 while maintaining at least a portion of the guiding elongate element 300 within the wire-receiving slot 425. As best shown in FIG. 6, the wire-sliding portion 424 of the clip body 420 is shaped and dimensioned to be received and to slide within the longitudinal wire-guiding slot 222 of the post heads 210. In the embodiment shown, the wire-sliding portion 424 of the clip body 420 has a cross-section corresponding substantially to the cross-section of the wire-mounting slot 222 formed in the post head 210. In the embodiment shown, the wire-sliding portion 424 of the clip body 420 has a substantially trapezoidal shape. Considered in a plane substantially transversal to a longitudinal direction of the portion of the guide wire 300 when arranged within the wire-receiving slot 425 (i.e., transversal to the head longitudinal direction L, i.e., transversal to the clip longitudinal direction C when the clip is arranged in the wire-mounting slot of the post head), the cross-section of the wire-sliding portion 424 of the clip body 420 diverges away from the membrane-mounting portion 422. As best shown in FIG. 5A, the clip body 420 comprises two clip arms 430, 432 and a coupling plate 434 (or flexible membrane-mounting plate 434) securing the two clip arms 430, 432 together. In the embodiment shown, the clip arms 430, 432 are substantially L-shaped and each comprises a membrane-mounting portion and a wire-sliding portion forming together at least partially the membrane-mounting portion 422 and the wire-sliding portion 424 of the clip body 420. As best shown in FIG. 5A, the wire-receiving slot 425 opens into the wire-sliding portion of the clip arms 430, 432 to form wire-engaging openings 431, 433 therein. Considered in a plane substantially perpendicular to the clip longitudinal direction C, the wire-engaging openings 431, 433 are substantially in register. In the embodiment shown, the wire-engaging openings open into a lateral portion of the clip arms 430, 432. For instance, the wire-engaging openings formed in the first and second clip arms form at least partially the wire-receiving slot, and the first and second clip arms converge toward each other their respective wire-engaging openings. It could also be conceived a membrane-deploying clip 1410 comprising a clip body 1420 which would be shaped and dimensioned, as represented for instance in FIGS. 15A to 15C, for the wire-engaging openings to open for instance in a lower portion of the clip arms 1430, 1432. In other words, the wire-receiving slot 1425 opens along a substantially transversal direction with respect to a membrane-mounting surface of the membrane-mounting portion 1422 of the clip body 1420 (i.e., the wire-receiving slot 1425 extends along a substantially vertical direction when the flexible membrane-mounting surface of the membrane-mounting portion is substantially horizontal). In other words, for instance, in the embodiment represented for instance in FIG. 15B, the clip body has a membrane-mounting side and an opposed ground-facing side, the wire-receiving slot opening into the ground-facing side. It is thus understood that the membrane-deploying clip according to this embodiment does not need to be mounted to a longitudinal border of the flexible membrane, but can be mounted or formed integral with a central portion thereof or could be mounted to or formed integral with a single-pieced flexible membrane. As represented in FIG. 15C, the membrane-deploying clip 1410 is shaped and dimensioned to cooperate with a guide wire-mounting post head 1210 with no mobile latch mounted to a post head body 1220 thereof. As represented in FIG. 15C, a wire-mounting slot 1222 is formed in the post head body 1220 and the post head 1210 further comprises a wire-mounting member 1224 arranged in the wire-mounting slot 1222 and secured (for instance via screws or any other suitable securing means) to a bottom wall portion 1225 of the post head body 1220, a portion of the guide wire 300 being sandwiched between the wire-mounting member and the bottom wall portion in order to limit the risk that the guide wire be accidently disengaged from the wire-mounting slot. The guide wire 300 being securely mounted to the post head 1210 via the wire-mounting member 1224, the guide wire contributes to the stability of the mounting of the post at the upper portion of which the post head 1210 is mounted. Similarly to the first embodiment described above, the post head 1210 comprises clip-actuating slopes to cooperate with the mobile locking member 1440 of the clip 1410. For instance in the embodiment represented in FIG. 5A, the clip body has a membrane-mounting side, an opposed ground-facing side and first and second longitudinal sides extending along the clip longitudinal direction between the membrane-mounting side and the ground-facing side, the wire-receiving slot opening into one of the first and second longitudinal sides.

In the embodiment shown, the wire-sliding portion has, considered with respect with the flexible membrane assembly, a proximal longitudinal side and a distal longitudinal side, both extending along the clip longitudinal direction; considered in a plane comprising the clip longitudinal direction and substantially parallel to a membrane-mounting surface of the membrane-mounting portion, a cross-section of the wire-sliding portion converges towards the distal longitudinal side. When secured together (for instance in a removable manner), the clip arms 430, 432 are spaced apart from each other along at least a portion of their respective membrane-mounting portions so as to define therebetween a locker-receiving space 435. The locker-receiving space 435 is shaped and dimensioned to receive at least partially the mobile locking member 440 when configured in the wire-engaging configuration (FIG. 5A). In the embodiment shown, as mentioned above, the mobile locking member 440 is arranged at least partially between the two clip arms 430, 432. As best shown in FIG. 5A, the mobile locking member 440 comprises a hooking portion 442 defining a wire-receiving channel 443 substantially in register with the wire-receiving slot 425 formed in the clip body 420. The hooking portion 442 comprises a peripheral wall 444 partially delimiting the wire-receiving channel 443. A wire-engaging opening 445 is formed in the peripheral wall 444 of the hooking portion 442 by the wire-receiving channel 443. As best shown in FIGS. 5A and 5B, when the mobile locking member 440 is configured in the wire-engaging configuration, considered in a plane substantially perpendicular to the clip longitudinal direction defined by the wire-receiving slot 425, the wire-engaging opening 445 of the mobile locking member 440 is substantially in register with the wire-engaging openings 431, 433 formed in the clip arms 430, 432 to allow introduction of the guide wire into the wire-receiving slot 425. In other words, the hooking portion has a peripheral wall at least partially delimiting a wire-receiving aperture substantially in register with the wire-receiving slot formed in the clip body, the wire-receiving aperture forming a wire-engaging opening in the peripheral wall of the hooking portion.

As best shown in FIG. 4A, when the mobile locking member 440 is configured in the wire-sliding configuration, considered in a plane substantially perpendicular to the clip longitudinal direction C, the wire-engaging opening 445 of the mobile locking member 440 is tangentially offset with respect to the wire-engaging openings 431, 433 formed in the clip arms 430, 432 to prevent the guide wire 300 from being removed from the wire-receiving slot 425 upon displacement of the guide wire in a direction substantially transversal to the clip longitudinal direction. In the embodiment shown, the mobile locking member 440 is shaped and dimensioned to be automatically configured into the wire-sliding configuration. In other words, the mobile locking member 440 is of the self-locking type. In the embodiment shown, the locking member 440 comprises a counterweight 447 (for instance at least partially made of lead) at an end portion 446 opposed to the hooking portion 442 to automatically configure the locking member 440 into the wire-sliding configuration due to gravity. In another embodiment (not represented), it could be conceived a membrane-deploying clip that would comprise a biasing member (such as a spring, an elastic member, a magnetic element, an elastic rod, for instance at least partially made of polypropylene and the like) configured to maintain the mobile locking member into the wire-sliding configuration so as to limit the risk that the guide wire accidentally escapes from the wire-receiving slot of the clip body.

As best shown in FIG. 9, the membrane-deploying clip 410 (for instance via the membrane-mounting portion 422 thereof) is mountable (for instance securable, for instance in a removable manner) to a clip-mounting strip 406 which is part of or is mounted to the longitudinal border 404 of the flexible membrane 402. In the embodiment wherein the clip-mounting strip is distinct from the flexible membrane, the clip-mounting strip 406 could be formed in a material different from a material of the flexible membrane 402 (for instance in a material being more rigid and/or more resistant and/or less elastic and/or less flexible than the material of the flexible membrane 402). For instance, the membrane-deploying clip 410 is configured so that the clip-mounting strip 406 (or membrane-reinforcing member 406) is at least partially sandwiched between the two clip arms 430, 432 and the coupling plate 434 when the membrane-deploying clip 410 is mounted to the clip-mounting strip 406. In the embodiment shown, as represented for instance in FIGS. 4A and 4B, the clip arms 430, 432 are tapered towards the wire-engaging openings 431, 433 formed therein. In other words, in a plane comprising the clip longitudinal axis C and substantially parallel to the membrane-mounting surface of the membrane-mounting portion 422, the wire-sliding portion 424 has a substantially V-shape. The shape of the wire-sliding portion 424 (for instance the shape of the clip arms 430, 432 forming at least partially the wire-sliding portion 424) thus eases the engagement of the membrane-deploying clip 410 (the engagement of the wire-sliding portion 424 thereof) in the below-described installation assembly. It could also be conceived a membrane-deploying clip with a single-pieced clip body. Due to its configuration, the clip-mounting strip 406 could be used to equip an existing flexible membrane with a plurality of membrane-deploying clips 410. The clips 410 can also be easily removed or replaced, for instance for maintenance purposes. It is thus understood that the membrane-deploying clip 410 is configured to be removably secured to the guiding elongate member 300 and to safely maintain the guiding elongate member 300 within the wire-receiving slot 425 when the mobile locking member 440 is configured in the wire-sliding configuration. The removable securing of the membrane-deploying clip 410 to the guiding elongate member 300 comprises configuring the mobile locking member 440 into the wire-engaging configuration, inserting the guiding elongate member 300 within the wire-receiving slot 425 via the wire-engaging openings 431, 433 of the clip arms 430, 432 and the wire-engaging opening 445 of the hooking portion 442 in register with each other. The removable securing of the membrane-deploying clip 410 to the guiding elongate member 300 then comprises configuring the mobile locking member 440 into the wire-sliding configuration. It is appreciated that the shape, the configuration of the membrane-deploying clip, as well as the shape, the configuration and the relative arrangement of the clip arms, the wire-engaging openings, the coupling plate and the self-lockable mobile locking member thereof, can vary from the embodiment shown. Cooperation between the flexible membrane-deploying clip and the guide wire-mounting post head. Once the membrane-deploying clip 410 is mounted to the guiding elongate element 300 and the guiding elongate element 300 is engaged with the wire-mounting slot 222 of the post head 210, the membrane-deploying clip 410 is slidable along the guiding elongate element 300 towards and away from the post head 210, as best shown in FIGS. 3, 7 and 8. When the membrane-deploying clip 410 reaches the post head 210, as represented in FIG. 3, the locking member 440 being configured into the wire-sliding configuration, the wire-sliding portion 424 of the clip body 420 enters the wire-mounting slot 222 via the first end portion 244 of the post head body 220 (i.e. at an inlet 227 of the wire-mounting slot 222, the inlet 227 being at least partially formed by the first longitudinal extremity 223 of the post head body). Upon contact of the locking member 440 with the clip-actuating slope 245 (i.e. sliding of the locking member 440 along the clip-actuating slope 245), as represented in FIG. 7, the locking member 440 is configured into the wire-engaging configuration so that the membrane-deploying clip 410 is configured into a compact configuration wherein the locking member 440 is at least partially received within the locker-receiving space at least partially delimited by the two clip arms and does not prevent the sliding of the wire-sliding portion 424 of the clip body 420 within the wire-mounting slot 222. Upon contact of the wire-sliding portion 424 of the clip body 420 with the pivoting latch 230, as represented in FIG. 7, the pivoting latch 230 is configured into the open position, so that the pivoting latch 230 does not prevent the sliding of the wire-sliding portion 424 of the clip body 420 along the guiding elongate element 300 within the wire-guiding slot 222. Upon further sliding of the wire-sliding portion 424 of the clip body 420 along the guiding elongate element 300, the wire-sliding portion 424 of the clip body 420 exits the wire-mounting slot 222 via the second end portion 246 at an outlet 249 of the wire-mounting slot 222. The outlet 249 is at least partially formed by the second longitudinal extremity 225. In particular due to the above-mentioned biasing members, the pivoting latch 230 is configured again into the closed position, to prevent the guiding elongate element 300 from escaping from the wire-mounting slot 222, as represented in FIG. 8. As mentioned above, when the clip body 420 (for instance the wire-sliding portion 424 thereof) is slid within the wire-mounting slot 222, the locking member 440 of the membrane-deploying clip 410 is configured into the wire-engaging configuration and the pivoting latch 230 is configured into the open position. However, the guiding elongate element 300 cannot escape from the wire-mounting slot 222 formed in the post head 210 due to the decreasing cross-section of the wire-mounting slot 222 towards the upper longitudinal side 240 which prevents the wire-sliding portion 424 of the clip body 420 from transversally escaping the wire-mounting slot 222. In other words, the guiding elongate member 300 is trapped between the membrane-mounting portion 422 of the clip body 420 and the lower longitudinal side 242 of the head body 220. Due to the above-mentioned second plane of symmetry of the post head 210 (i.e. the plane of symmetry substantially perpendicular to the head longitudinal direction L and the upper and lower longitudinal sides 240, 242), the membrane-deploying clip 410 can be slid along the guiding elongate element 300 in a second direction opposed to the first direction detailed above (for instance to configure the flexible membrane assembly back into the undeployed configuration).

Other Possible Features of the Field Protection System

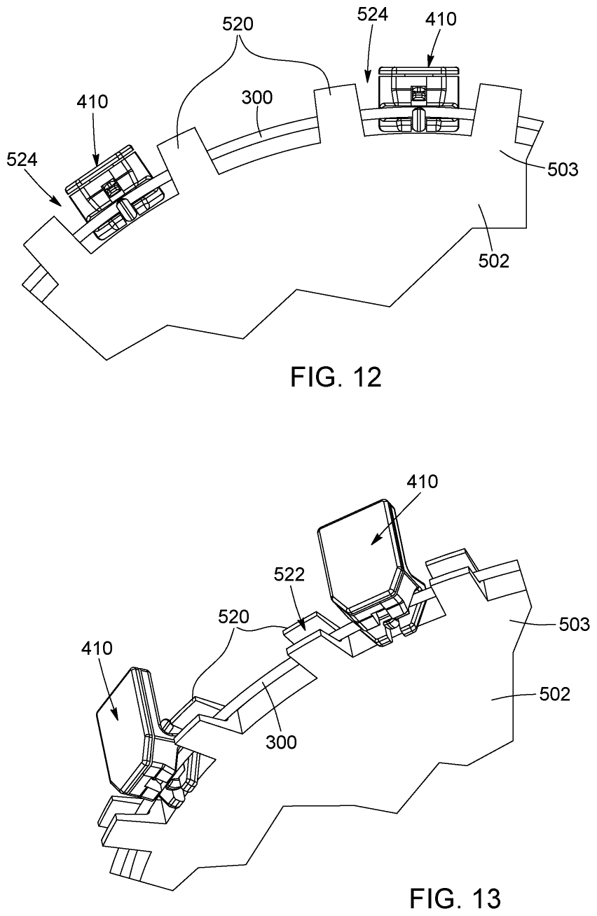

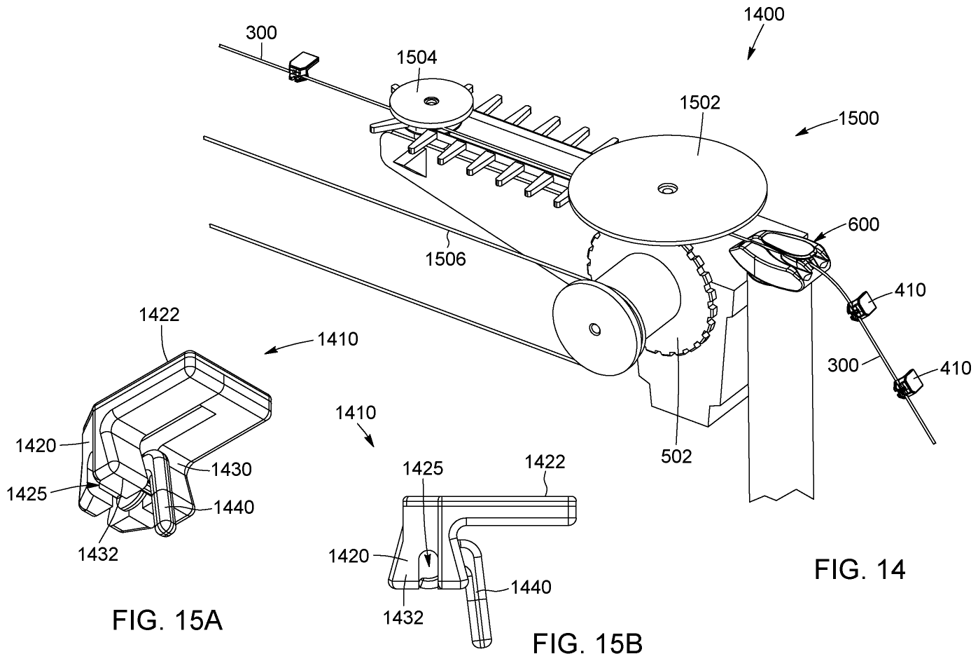

As mentioned above, the motorized membrane-deploying system 500 of the bush protection system 100 is configured to assist the deployment of the flexible membrane assembly 400 above the area to be protected. As represented in FIGS. 1, 12 and 13, the motorized membrane-deploying system 500 comprises toothed pulleys 502, 504 mounted to vertical posts located at opposed ends of the field or area to be protected. The membrane-deploying system 500 further comprises a deploying belt 506 arranged between the toothed pulleys 502, 504 to drive the deployable flexible membrane assembly 400 along the guiding elongate element 300. The membrane-deploying system 500 comprises a motor 508 and a coupling belt operatively coupling the motor 508 to one of the toothed pulleys 502. In the embodiment shown, the toothed pulleys 502, 504 have a similar shape, so that the following description of one of the toothed pulleys 502, 504 will apply to both of them. As best shown in FIGS. 12 and 13, the toothed pulley 502 comprises a plurality of teeth 520 outwardly extending from an inner core 503 of the toothed pulley 502 and regularly spaced apart from each other along an outer periphery of the inner core 503 of the pulley 502. A guide wire-supporting groove 522 is formed in the teeth 520 to support the guiding elongate element 300 upon rotation of the toothed pulley 502. Clip-receiving gaps 524 are defined between adjacent teeth 520 which are shaped and dimensioned to receive a membrane-deploying clip 410 therein. Moreover, the teeth 520 are high enough for the membrane-deploying clips 410 to be contained in the clip-receiving gaps 524 without contacting the inner core 503 of the toothed pulley 502. It is thus understood that the toothed pulleys 502, 504 are shaped and dimensioned to deploy the flexible membrane assembly 400 and to retract the flexible membrane assembly 400, for instance at an end of a harvest season. Upon actuation of the above-mentioned motor 508 (FIG. 1), the membrane-deploying clips 410 are captured between adjacent teeth 520 to configure the flexible membrane assembly 400 in the undeployed configuration (i.e. in a membrane-resting configuration). It is understood that the toothed pulleys 502, 504 are shaped and dimensioned so that the teeth 520 thereof support the guiding elongate element 300 while a limited pressure is applied to the membrane-deploying clips 410. It is appreciated that the shape, the configuration of the motorized membrane-deploying system, as well as the shape, the configuration and the relative arrangement of the toothed pulleys and the deploying belt, can vary from the embodiment shown. It could also be a membrane-deploying system which would not comprise one or more toothed pulleys but only a frictional member to deploy and/or retract the flexible membrane assembly (i.e. to contribute to the sliding of the membrane-deploying clips along the guiding wire). For instance, as best shown in FIG. 14, the membrane-deploying system 1500 could comprise a toothed pulley 1502 extending in a plane substantially parallel to the flexible membrane (not represented). In the embodiment shown, the toothed pulley 1502 is rotatably mounted about a substantially vertical rotation axis. For instance, one of the toothed pulleys 1502, 1504 is arranged at an outlet of an installation assembly 600. For instance, the toothed pulley 1502 is arranged so that the guiding elongate member 300 and the clip-mounting strip of the flexible membrane assembly extend substantially parallel to each other on opposed sides of the toothed pulley 1502. This arrangement limits constraints applied to the toothed pulley, the membrane-deploying clips and/or the guiding elongate element. The deploying belt 1506 comprises a plurality of clip-guiding teeth to guide the membrane-deploying clips upon deployment of the flexible membrane assembly 1400.

As best shown in FIGS. 10 and 11, the bush protection system 100 could also comprise an installation assembly 600 (or clip-mounting assembly 600) to mount the membrane-deploying clips 410 to the guiding elongate element 300. In the embodiment shown, the clip-mounting assembly 600 has at least one clip-guiding slot 610 (two, in the embodiment shown) formed therein to mount the flexible membrane assembly 400 to the guiding elongate element 300 via the membrane-deploying clips 410 thereof. The clip-mounting slot 610 is shaped and dimensioned to receive therein the membrane-deploying clip 410 in the compact configuration (i.e. with the locking member being configured into the wire-engaging configuration). In the embodiment shown, the clip-mounting slot 610 has a cross-section substantially similar to the cross-section of the wire-mounting slot 222 of the post head 210, for instance substantially trapezoidal in the embodiment shown). The clip-mounting slot 610 is dividable, considered along a longitudinal direction of the clip-mounting assembly 600, into a clip-engaging portion 620, a clip-mounting portion 630 and an outlet 640. A guide wire-receiving slot 650 is also formed into the clip-mounting assembly 600 which intersects the clip-mounting slot 610 at the clip-mounting portion 630 thereof.

It is understood that the clip-engaging portion of the clip-mounting slot could be replaced by a clip-maintaining element (for instance a string or a cable) extending upstream of the clip-mounting portion and configured to maintain the membrane-deploying clips in a predetermined order prior to their mounting to the guiding elongate element. The clip-mounting assembly is configured to ease the removal of the flexible membrane assembly from the protected area, for instance to store and/or maintain the flexible membrane assembly. Upon displacement of the clip-mounting assembly 600 with at least one membrane-deploying clip 410 engaged in the clip-engaging portion 620 of the clip-mounting slot 610, the membrane-deploying clip 410 is directed (i.e. slid along the clip-mounting slot 610) towards the clip-mounting portion 630 wherein the membrane-deploying clip 410 with the mobile locking member 440 configured into the wire-engaging configuration is mounted to the guide wire 300 (i.e. the guide wire 300 is introduced into the wire-receiving slot 425 of the membrane-deploying clip 410). Upon further displacement of the clip-mounting assembly 600, the membrane-deploying clip 410 mounted to the guide wire 300 reaches the outlet 640 of the clip-mounting slot 610 and exits the clip-mounting slot 610 wherein the mobile locking member 440 is automatically configured into the wire-sliding configuration. It is thus understood that the clip-mounting assembly 600 works substantially similarly to a zipper slider. In the embodiment shown, a clip-actuating slope 601 (or clip-actuating ramp 601) substantially similar to the clip-actuating slope 245 of the post head 210 is formed at the outlet 640 of the clip-mounting slot 610. It is thus understood that the clip-mounting assembly 600 could be displaced in an opposed direction to remove the membrane-deploying clips 410 from the guiding elongate element 300 for instance for maintenance purposes. In the embodiment shown, the clip-mounting assembly 600 further comprise a membrane-maintaining member 611 extending above the clip-guiding slots 610 in order to maintain the clip-mounting strips of the flexible membrane assemblies into the clip-guiding slots via the membrane-deploying clips. In the embodiment shown, the clip-guiding slot 610 comprises two clip-engaging portions 620 at least partially spaced apart from each other and converging towards each other at the clip-mounting portion 630. The clip-mounting assembly 600 is thus configured to mount membrane-deploying clips 410 of two distinct flexible membrane assemblies to the same guiding elongate element 300. For instance, the membrane-deploying clips 410 are mounted in a staggered manner to the longitudinal border of the corresponding flexible membrane assemblies, for instance on top of one of the vertical posts extending at an end portion of the area to be protected. It is appreciated that the shape and the configuration of the clip-mounting assembly can vary from the embodiment shown. The flexible membrane of the two flexible membrane assemblies could be configured in an overlapping configuration when mounted to the same guiding elongate element 300 to better protect the area (for instance to limit the risk that birds or the like would enter and get trapped in a space covered by the flexible membrane assemblies 400). For instance, the plurality of the flexible membrane assemblies could be arranged at different levels (i.e. at different vertical positions) in order to form a protective canopy with one or more sloping roof portions in order to ease flowing of water, hail and the like from the field protection system.

Method for Forming a Protective Canopy Over an Area

According to another aspect of the disclosure, there is provided a method for forming a protective canopy over an area. The method according to embodiments of the present disclosure may be carried out with a field protection system 100 as the ones described above. In the embodiment shown, the method comprises arranging a plurality of guide wire-mounting post heads 210 above said area, each of said guide wire-mounting post heads 210 having a wire-mounting slot 222 formed therein; inserting a guide wire 300 in the wire-mounting slots 222; securing first and second end portions 302, 304 of the guide wire 300 to a ground surface surrounding said area; providing a flexible membrane assembly 400 comprising a flexible membrane and a plurality of flexible membrane-deploying clips 410 mounted thereto (for instance to a longitudinal border thereof, to a central portion thereof or to any other location thereof); engaging the plurality of membrane-deploying clips 410 with the guide wire 300 at one of the first and second end portions thereof; and sliding the plurality of membrane-deploying clips 410 along the guide wire 300 towards the other of the first and second end portions thereof to deploy the flexible membrane assembly 400 over said area to form the protective canopy. For instance the guide wire-mounting post heads 210 are arranged between about 2 feet and about 15 feet above the area to be protected. In another embodiment, the guide wire-mounting post heads 210 are arranged between about 5 feet and about 10 feet above the area. It is thus understood that the field protection system 100 (or area-covering system 100) is configured to easily deploy the flexible membrane assembly 400 via the sliding of the membrane-deploying clips 410 thereof along the guiding elongate element 300. Moreover, the different components of the field protection system 100 are configured so that the flexible membrane assembly 400 cannot be accidentally—or unintentionally—disconnected from the guiding elongate element 300 and so that the guiding elongate element 300 cannot be accidentally—or unintentionally—disconnected from the post heads 210. By being removably mounted to the guiding-elongate element 300 via the membrane-deploying clips 410, the flexible membrane assembly 400 can be removed from the protected area, for instance for maintenance purposes or when the weather requires it. It is also understood that the flexible membrane assembly 400 could easily be retracted by sliding the membrane-deploying clips 410 along the guiding elongate element 300 in a direction opposed to the one corresponding to the deployment of the flexible membrane assembly over the area to be protected. It is thus understood that the flexible membrane assembly of the field protection system is easily deployable and retractable along a length of the area to be protected (i.e. deployable and retractable along the longitudinal direction of the guiding elongate element 300). When mounted to the guiding elongate element and configured in the deployed configuration, the flexible membrane assembly forms a protective canopy over the protected area (or protected field, or protected corps) and extends above the vertical posts supporting the post heads. It is also understood that when the area is covered by a plurality of flexible membrane assemblies extending substantially parallel to each other, one of the flexible membrane assemblies can easily be removed without having to remove the other flexible membrane assemblies, thus easing maintenance operations.

Field Protection Systems with Foldable Frame Members

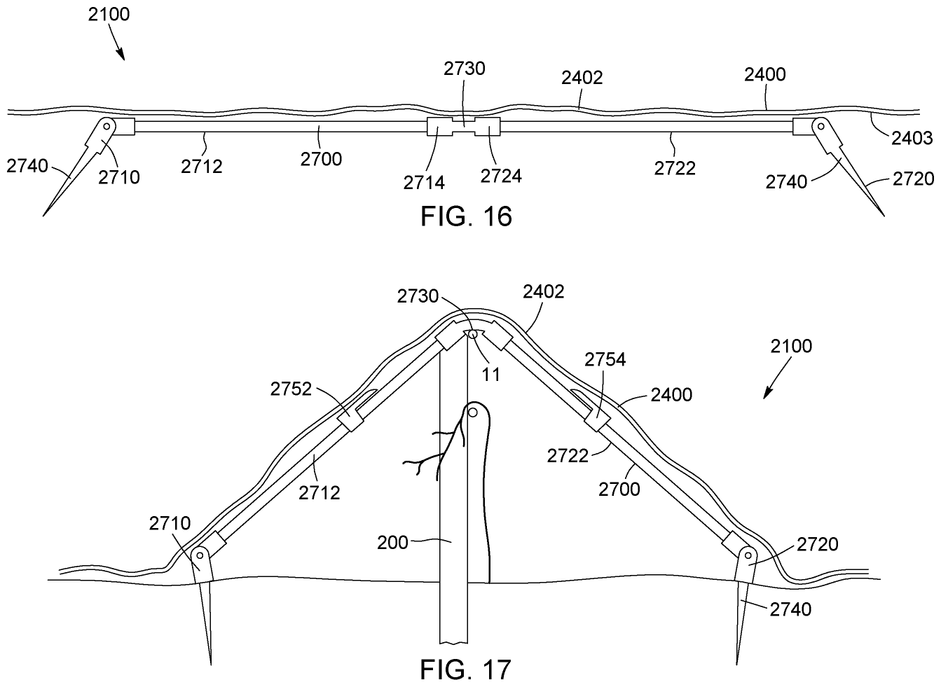

Referring now to FIGS. 16 and 17, there is shown a field protection system 2100 (or bush protection system 2100 or winter protection system 2100 or protective canopy system 2100 or deployable crop protection system 2100 or crop roofing system 2100) in accordance with another embodiment. The field protection system 2100 could be used, for instance and without being limitative, to protect grapevine plants or any other plants during winter. The field protection system 2100 can be used in cooperation with one or more cables extending substantially horizontally (for instance extending between vertically extending poles) in the field being protected, over the area to be protected.

Field Protection System

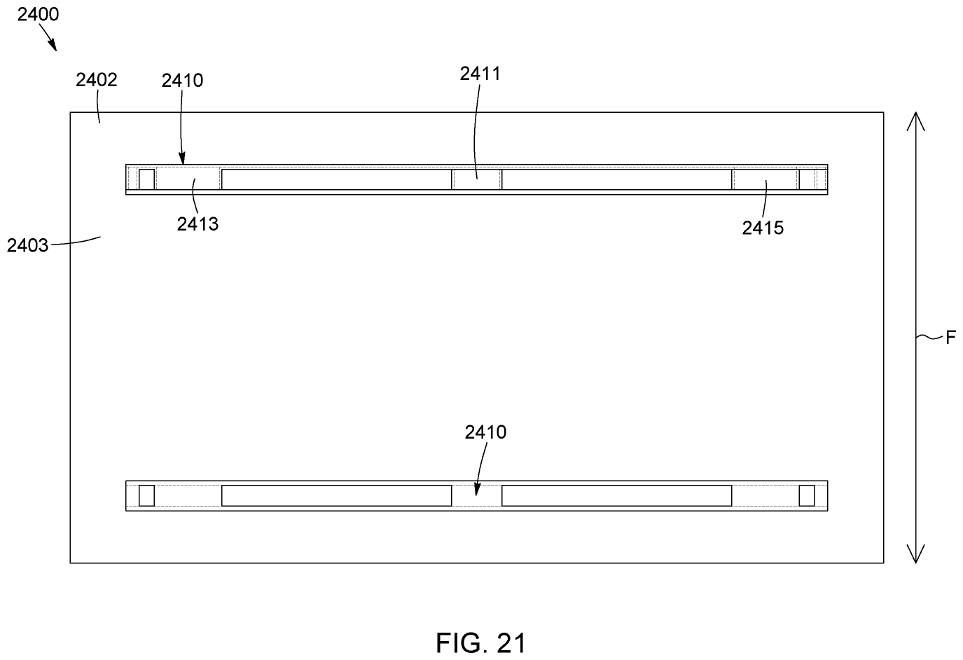

The field protection system 2100 comprises a flexible membrane assembly 2400 comprising a flexible membrane 2402 (for instance at least partially formed of a geotextile membrane, net, mosquito net, plastic films, fabrics, canvas, or any other suitable flexible material) having a field-facing surface 2403 and a plurality of frame-receiving hems 2410 (FIG. 21) secured to or formed integral with the field-facing surface 2403 of the flexible membrane 2402. For instance, the frame-receiving hems 2410 form frame-receiving sleeves which are sewed to the field-facing surface 2403 of the flexible membrane 2402. The field protection system 2100 further comprises a plurality of foldable frame members 2700 at least partially engaged with the field-facing surface 2403 thereof (for instance via the frame-receiving hems 2410), each comprising first and second opposed ground-securing end portions 2710, 2720. In the embodiment shown, the foldable frame member 2700 comprises first and second frame legs 2712, 2722 connected to each other, each of the first and second frame legs 2712, 2722 comprising a ground-securing end portion 2710, 2720 and an opposed connecting portion. The first and second frame legs are thus pivotally connected to each other via their respective connecting portions. As detailed below, the ground-securing end portions 2710, 2720 can either be secured directly to the ground, or indirectly, for instance via bottom cables extending at least partially along a peripheral border of the field area to be protected.

Foldable Frame Members

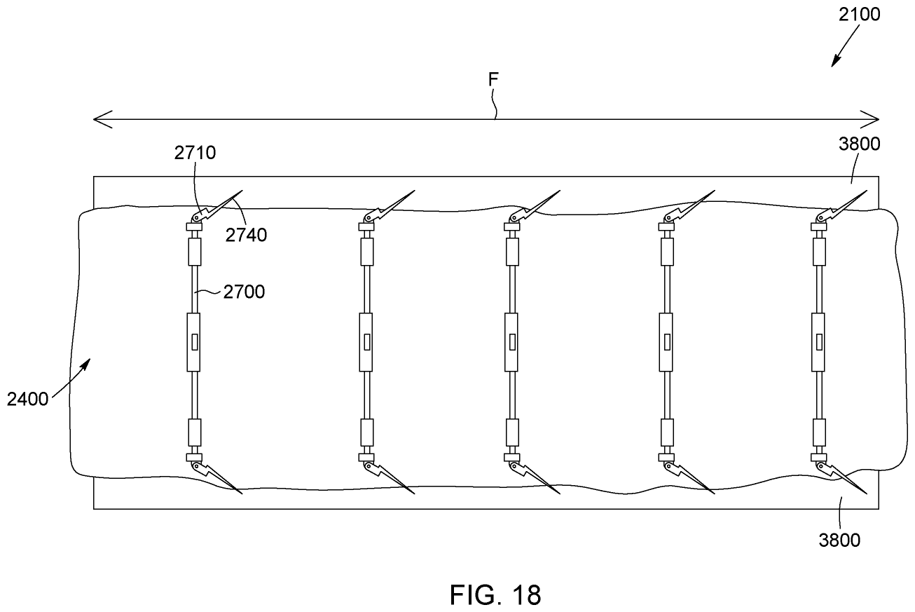

In the embodiment shown, the flexible membrane assembly 2400 defines a flexible membrane longitudinal direction F (FIG. 18), the field protection system 2100 comprising a plurality of foldable frame members arranged transversally (for instance substantially perpendicularly) to the flexible membrane longitudinal direction F of the flexible membrane assembly 2400. For instance, the foldable frame members are regularly spaced apart from each other along the flexible membrane longitudinal direction F. In the embodiment shown, the foldable frame members 2700 have a similar shape, so that the following description of one of the foldable frame members 2700 will apply to any of them. The foldable frame member 2700 comprises first and second frame legs 2712, 2722, each comprising one of the above-mentioned ground-securing end portions 2710, 2720 and a connecting portion 2714, 2724. The foldable frame member 2700 further comprises a flexible junction 2730 connecting the connecting portions of the first and second frame legs 2712, 2722. The foldable frame member 2700 is thus configurable into a storage or deployment configuration (FIG. 16), wherein the first and second frame legs are substantially aligned with each other, so that the protection system can easily be unrolled to be configured into the deployment configuration or rolled up (or folded) when not in use to be configured into the storage configuration. The foldable frame members 2700 are also configurable into a protection configuration (FIG. 17), wherein the first and second frame legs 2712, 2722 are inclined with respect with each other with the flexible junction 2730 forming an apex of the foldable frame member 2700, to define a protection chamber at least partially delimited by the field-facing surface 2403 of the flexible membrane 2402. In other words, each of the first and second frame legs comprises a first longitudinal end portion forming at least partially the ground-securing end portion, and an opposed second longitudinal end portion forming at least partially the connecting portion.

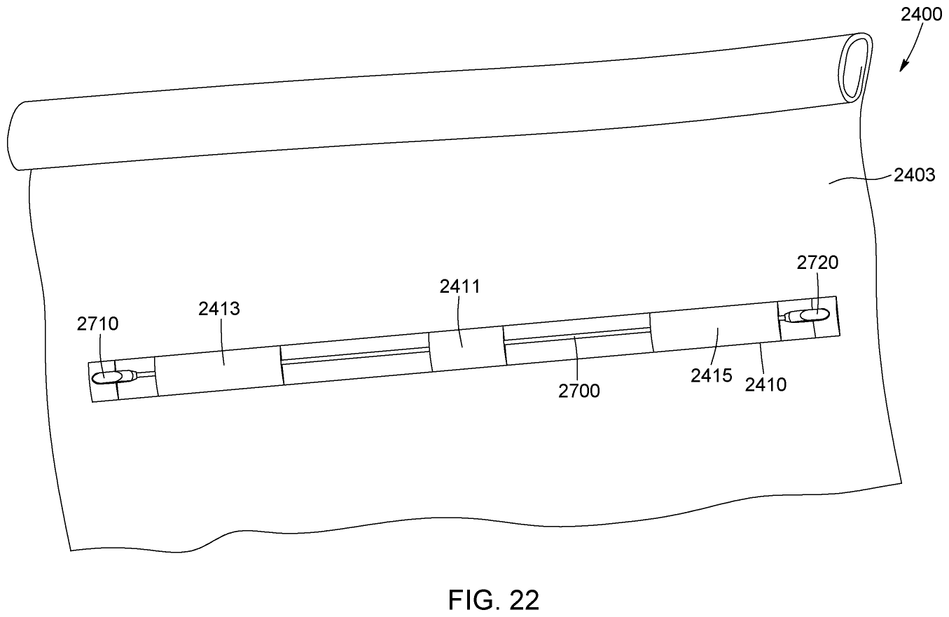

For instance, the flexible junction 2730 comprises a rubber sheath receiving or formed integral with the connecting portions of the first and second frame legs 2712, 2722. Any other means could be conceived to create a hinge or articulated joint between the first and second frame legs 2712, 2722. For instance, the first and second frame legs 2712, 2722 are at least partially formed of fiber glass, reinforced polymer, fiber glass reinforced polymer, wood dowel, metal rods, plastic, metal tub and the like. As best shown in FIGS. 18, 21 and 22, the frame-receiving hems 2410 are secured to or formed integral with the field-facing surface 2403 of the flexible membrane 2402. The frame-receiving hems 2410 are substantially transversal (for instance substantially perpendicular) to the flexible membrane longitudinal direction F of the flexible membrane assembly 2400. For instance, the frame-receiving hem 2410 comprises a central portion 2411 to maintain the flexible junction 2730 of the corresponding foldable frame member 2700 and first and second lateral portions 2413, 2415 shaped and dimensioned to maintain at least partially the first and second frame legs of the corresponding foldable frame member 2700 while uncovering the first and second ground-securing end portions thereof. Any other shape of the frame-receiving hems 2410 could be conceived. For instance, the flexible membrane assembly 2400 is deployable over a protection-supporting cable 11 extending over (for instance centrally) the field area to be protected. For instance, the protection-supporting cable 11 is maintained at a distance from the ground surface via a plurality of vertical posts 200. Different embodiments of the first and second ground-securing end portions of the foldable frame member could be conceived and will now be described.

Foldable Frame Members with Spikes

As best shown in FIGS. 16 and 17, the ground-securing end portions 2710, 2720 each comprise a spike 2740 at least partially engageable with the ground surrounding the field area to be protected. For instance, in the embodiment shown, the ground-securing end portion 2710, 2720 is pivotally mounted to a frame leg body of the corresponding frame leg 2712, 2722. The spikes could thus contribute to maintaining the flexible frame assembly 2400 above the field area to be protected, when the foldable frame member 2700 is configured in the protection configuration, while enabling the field protection system to be easily stored, when the foldable frame member is configured in the storage configuration.

Foldable Frame Members Engageable with Bottom Cables

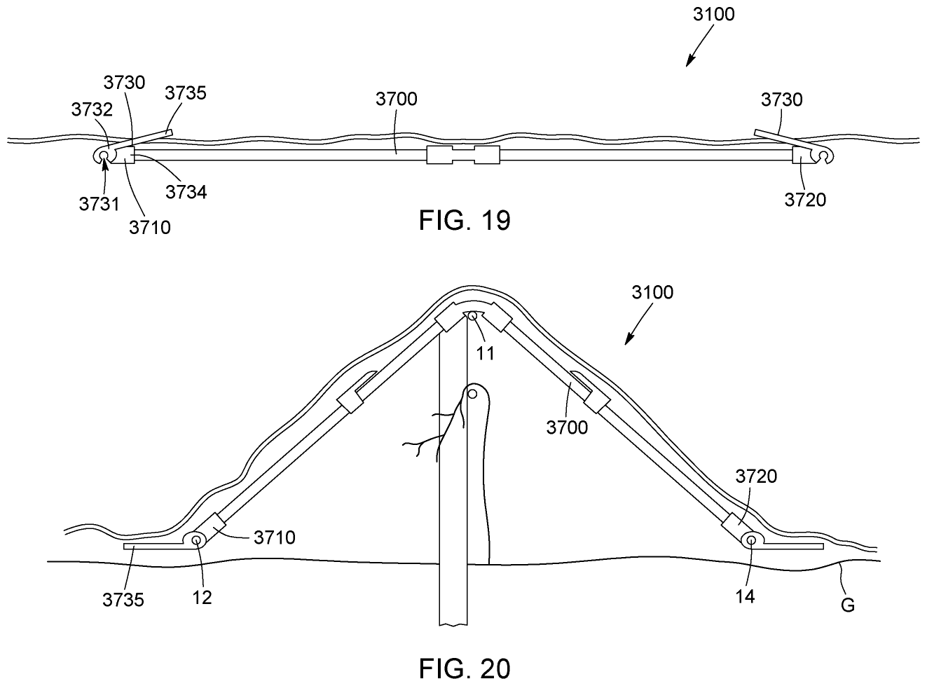

In another embodiment, as represented for instance in FIGS. 19 and 20, the protection system 3100 is used in a field comprising bottom cables 12, 14 extending close to a ground surface G. For instance, the ground-securing end portions 3710, 3720 of the foldable frame member 3700 comprise a cable-engaging hook 3730. For instance, the cable-engaging hook 3730 defines a closable cable-receiving cavity 3731 and comprises a locking member 3732 (or pivotable locking member 3732, or mobile locking member 3732) to configure the ground-securing end portion 3710 in an installation configuration (FIG. 19), wherein the corresponding bottom cable can be at least partially engaged with (i.e., introduced in in a substantially radial direction considered with respect with the cable-receiving cavity 3731) the cable-receiving cavity 3731, and in a protection configuration (FIG. 20), wherein the bottom cable cannot be extracted from the cable-receiving cavity 3731 in the radial direction. In the embodiment shown, the cable-engaging hook 3730 is shaped and dimensioned so that the cable-engaging hook can slide along the bottom cable when the corresponding ground-securing end portion is configured in the protection configuration. In the embodiment shown, the locking member 3732 is pivotally mounted to a hook body 3734 (or leg body-mounting member 3734 or leg body-engaging member 3734) of the ground-securing end portion. For instance, the hook body 3734 defines a leg body-receiving sleeve engageable with the frame leg body of the corresponding frame leg. In the embodiment shown, the ground-securing end portion is configurable from one of the installation and protection configurations into the other one upon pivoting of the locking member 3732. As best shown in FIG. 20, the ground-securing end portion might further comprise a ballast-receiving member 3735 extending substantially horizontally when the ground-securing end portion is in the protection configuration. For instance, the ballast-receiving member 3735 is formed integral with the locking member and contributes to the stability of the installation of the field protection system 3100: a weight (for instance a bag or a quantity of land) can be provided onto a substantially planar portion of the ballast-receiving member in order to prevent it from pivoting into the installation configuration. When the ground-securing end portion is in the installation configuration (FIG. 19), the ballast-receiving member 3735 is at least partially superposed onto the frame leg body.

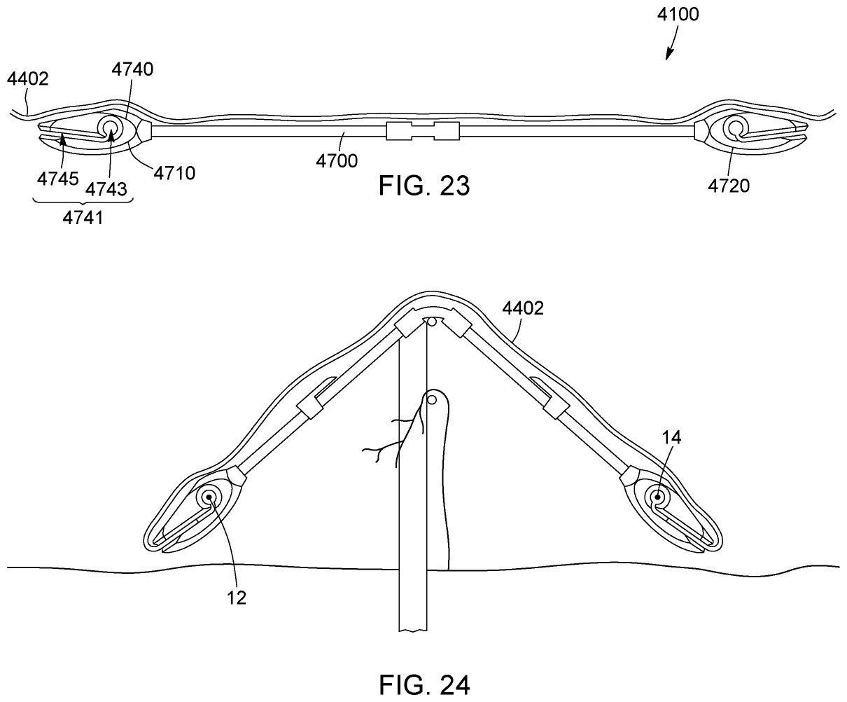

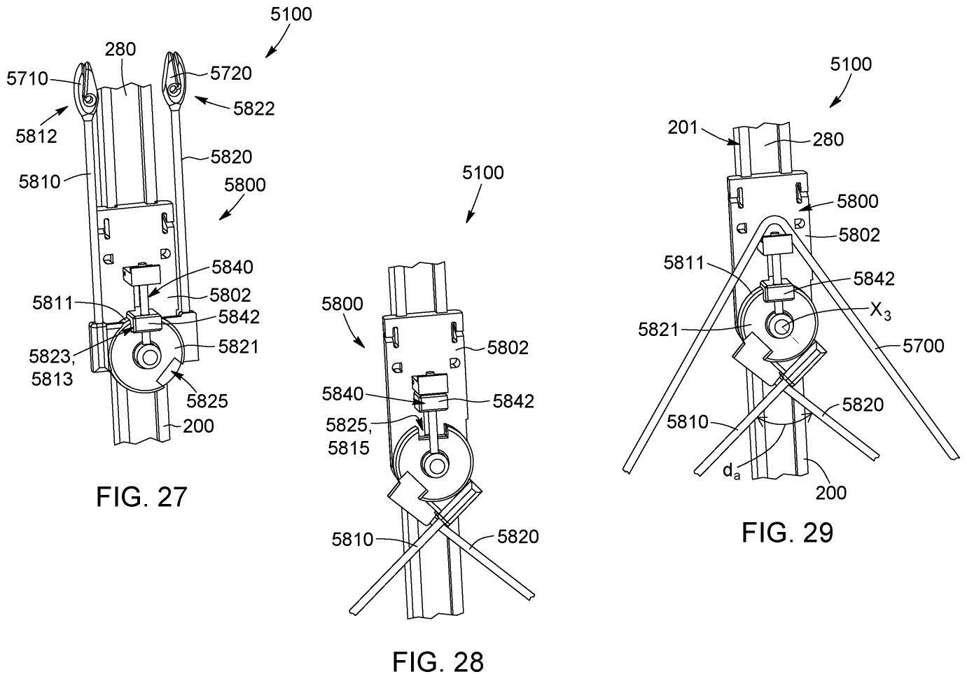

FIGS. 23 and 24 represent another possible embodiment of a field protection system 4100 configured to be used in a field comprising bottom cables 12, 14 extending close to the ground surface of or at least partially surrounding the field area to be protected. The ground-securing end portions 4710, 4720 of the foldable frame member 4700 each comprise a cable-engaging hook 4740. For instance, the cable-engaging hook 4740 defines a cable-engaging slot 4741 dividable into a cable-retaining end portion 4743 and a membrane-receiving portion 4745 opening into the cable-retaining end portion 4743. When configured into the installation configuration, the bottom cable can be introduced along a radial direction into the cable-retaining end portion 4743 via the membrane-receiving portion 4745. When configured in the protection configuration, with the bottom cable being arranged in the cable-retaining end portion 4743, at least a portion of a longitudinal border of the flexible membrane 4402 can be engaged in the membrane-receiving portion 4745 of the cable-engaging slot 4741 (FIG. 24). The engagement of the flexible membrane with the cable-engaging hook thus contributes to maintaining the bottom cable into the cable-retaining end portion by preventing accidental removal therefrom. FIGS. 27 to 29 show another possible embodiment of a field protection system 5100 configured to be used in a field comprising bottom cables extending close to the ground surface of or at least partially surrounding the field area to be protected. In the embodiment shown, the bottom cables, when not arranged close to the ground surface, might be secured to a vertical post extension 280 (FIG. 29). In the embodiment shown, the protection system 5100 comprises a plurality of vertical post assemblies 201, each comprising a vertical post 200 and the vertical post extension 280 removably mountable to a post head of the vertical post 200. It is thus understood that the vertical post assembly 201 is thus configurable into an extended configuration wherein the vertical post 200 and the vertical post extension 280 are substantially aligned with each other (FIG. 29), in a substantially vertical configuration. In the extended configuration, the bottom cables might form plant-supporting cables engaged with the vertical post extension 280. The field protection system 5100 further comprises a deployable pole-mounting base assembly 5800 comprising a pole-mounting base 5802 and first and second cable-engaging arms 5810, 5820 pivotally mounted to the pole-mounting base 5802. For instance, the pole-mounting base assembly 5800 is mounted to a base portion of the of vertical post assembly 201 (for instance to a lower portion of the vertical post 200 but it could be mounted anywhere else along the vertical post 200) via the pole-mounting base 5802. The deployable pole-mounting base assembly 5800 is configurable into a retracted configuration, as best shown in FIG. 27, wherein the first and second cable-engaging arms 5810, 5820 extend along a portion of the pole base 200 (or vertical post 200) of the vertical post assembly 201. The first and second arms 5810, 5820 thus extend substantially parallel to each other when in the retracted configuration to at least partially surround the pole base 200. In the retracted configuration, cable-engaging end portions 5710, 5720 of the first and second arms 5810, 5820 are proximate each other. The vertical post assembly 201 is also configurable into a protection configuration (FIGS. 28 and 29) wherein the cables are removed from the vertical post extension 280 and are arranged onto or in the vicinity of the ground surface. The vertical post extension 280 might then be disengaged from the post base 200 and can be stored, or can be kept assembled with the post base 200. When the vertical post assembly 201 is configured into the protection configuration, the deployable pole-mounting base assembly 5800 is configured into a deployed configuration, wherein the first and second arms 5810, 5820 extend in opposed directions away from the pole-mounting base 5802, thereby forming therebetween a deployment angle da. In the embodiment shown, each of the first and second cable-engaging arms comprises a base-mounting portion 5811, 5821. In the embodiment shown, the base-mounting portions are substantially disk-shaped and are pivotally mounted to the pole-mounting base 5802 about a common rotation axis X3. In the embodiment shown, at least two distinct locker-receiving apertures 5813, 5815, 5823, 5825 are formed in each base-mounting portions (for instance in a peripheral portion thereof) which are shaped and dimensioned to receive at least partially a locker 5842 when the deployable base assembly is configured in each one of the retracted and deployed configurations. In other words, the deployable pole-mounting base assembly 5800 comprises a locking system 5840 to lock the deployable base assembly 5800 in at least one of the retracted and deployed configurations (in both of them, in the embodiment shown). The locking system 5840 comprises the mobile (for instance translatable) locker 5842, which is configurable into an unlocking configuration (FIG. 28), in which the locker is not engaged in any one of the locker-receiving apertures, so that the base-mounting portions are pivotable about the common rotation axis X3. The translatable locker 5842 is further configurable into a locking configuration, wherein the locker is engaged in locking-receiving apertures of the base-mounting portions of the first and second arms 5810, 5820 (FIG. 27, when the base assembly is in the retracted configuration, and FIG. 29, when the base assembly is in the deployed configuration). Any other locking system could be configured. Moreover, the disclosure is not limited to a deployable base assembly that can only be configured in two distinct configurations. Additional locker-receiving apertures could be formed in the base-mounting portions in order to configure the base assembly into additional configurations (i.e., in additional deployed configurations defining deployment angles having values different from da). As represented in FIG. 29, the deployable base assembly 5800 might further be configured to at least partially support a foldable frame member.

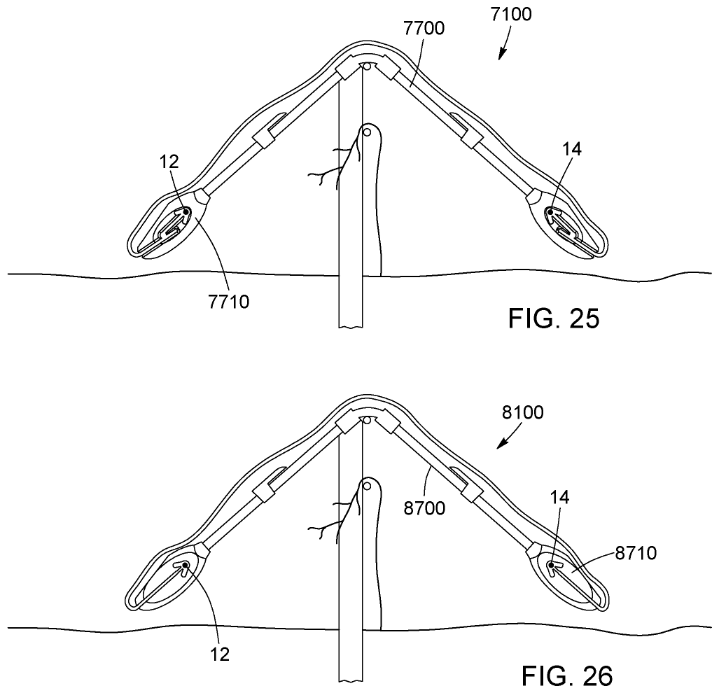

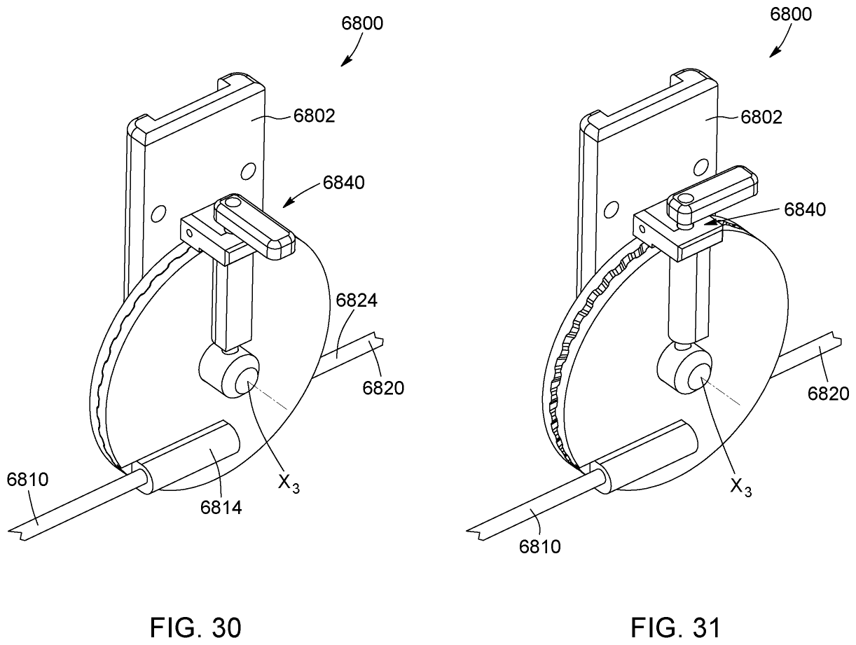

FIGS. 30 and 31 represent another possible embodiment of a deployable pole-mounting base assembly 6800 comprising a pole-mounting base 6802 and first and second cable-engaging arms 6810, 6820 pivotally mounted to the pole-mounting base and each comprising a cable-engaging end portion, the deployable base assembly being configurable into at least a retracted configuration (not represented) wherein the cable-engaging end portions are proximate each other, and into a deployed configuration, wherein the first and second cable-engaging arms extend in opposed directions away from the pole-mounting base, thereby forming therebetween a deployment angle. In the deployed configuration, the first and second cable-engaging arms 6810, 6820 extend along the ground surface and are substantially aligned with each other, with the bottom cables being secured to or engaged with distal end portions of the first and second arms 6810, 6820. The first and second arms 6810, 6820 are rotatably mounted to the pole-mounting base 6802, for instance about a common rotation axis X3. It could also be conceived a deployable base assembly with axes of rotation of the first and second arms being distinct from each other, for instance substantially parallel to each other. In the embodiment shown, the first and second arms 6810, 6820 are mounted to the pole-mounting base 6802 (or arm-mounting member) via proximal end portions 6814, 6824 thereof. For instance, the proximal end portions are substantially disk shaped and are substantially in register with each other. For instance and as detailed below, facing surfaces of the proximal end portions 6814, 6824 have mating profiles. In other words, each of the first and second arms comprises a toothed disk, each of the toothed disks comprising an indented surface, the indented surfaces of the toothed disks facing each other. In the embodiment shown, the base assembly 6800 further comprises a locking system 6840 to lock the first and second arms 6810, 6820 in either one of the deployed and retracted configurations, or in any intermediate configuration, between the deployed and retracted configurations. When the locking system 6840 is in an unlocked configuration (FIG. 31), the proximal end portions 6814, 6824 are spaced apart from each other, so that the first and second arms 6810, 6820 are free from rotating about the rotation axis X3, for the deployable base-assembly 6800 to be configured in the deployed configuration, the retracted configuration or any intermediate configuration therebetween. When the locking system 6840 is in a locked configuration (FIG. 30), the proximal end portions 6814, 6824 of the first and second arms 6810, 6820 are brought toward each other (in an axial direction, considered with respect to the rotation axis X3), so that their facing indented surfaces contact each other. Due to the mating profiles of the facing surfaces of the proximal end portions 6814, 6824, when the locking system 6840 is in the locked configuration, the first and second arms 6810, 6820 (for instance the proximal end portions 6814, 6824 thereof) are prevented from rotating about the rotation axis X3. In other words, in the embodiment shown, the deployable pole-mounting base assembly 6800 comprises two toothed disks, forming at least partially the proximal end portions of the first and second arms 6810, 6820, the toothed disks being either rotatable with respect to each other, or angularly coupled to each other. Any other shape and configuration of the locking system could be conceived. As best shown in FIG. 27, the distal end portions 5812, 5822 of the first and second arms 5810, 5820 might comprise cable-engaging hooks defining a cable-receiving cavity. The cable-receiving cavity is shaped and dimensioned to receive and maintain a portion of the corresponding bottom cables when the vertical post assembly 201 is configured in the protection configuration. The cable-engaging hooks might be similar to or different from the cable-engaging hooks arranged at or formed integral with the ground-securing end portions of the foldable frame members. FIGS. 25 and 26 represent other possible field protection systems 7100, 8100 with foldable frame members 7700, 8700 with ground-securing end portions 7710, 8710 having different shapes, the ground-securing portions comprising cable-receiving cavities which are shaped and dimensioned to allow an easy radial introduction of the cable therein, while safely maintaining the cable therein by limiting the risk of an accidental removal of the portion of the cable therefrom. It is understood that the disclosed ground-securing end portions could also be arranged on distal end portions of the cable-engaging arms of the deployable base assembly in accordance with any of the described embodiments.

It is understood that the shape and the configuration of the pole-mounting base assembly, as well as the shape, the configuration and/or the respective location of the first and second arms, the arm-mounting member and/or the locking system thereof can vary from the embodiment shown.

Other Possible Features of the Foldable Frame Member:

As best shown for instance in FIG. 17, the foldable frame member 2700 might further comprise first and second membrane-receiving members 2752, 2754 mounted (for instance slidably) respectively to the first and second frame legs 2712, 2722. For instance, the membrane-receiving member 2752, 2754 is mounted to a substantially central portion of the frame leg body of the corresponding frame leg and is shaped and dimensioned to maintain a portion of the flexible membrane to configure the flexible membrane in a partially protecting configuration. The first and second membrane-receiving members 2752, 2754 thus allow for instance air circulation between the protection chamber at least partially delimited by the flexible membrane assembly 2400 and an exterior thereof, in order to ease drying of the plant and to allow circulation of light and air while substantially protecting the plants. It is understood that, in the embodiment wherein the foldable frame member comprises one or more membrane-receiving members, the corresponding frame-receiving hem 2410 mounted to or formed integral with the field-facing surface of the flexible membrane is shaped and dimensioned for the membrane-receiving member to be easily reachable from under the field protection system.

Method for Forming a Protection Over an Area

According to another aspect of the disclosure, there is provided a method for forming a protection over an area (for instance a field), the method comprising: arranging a protection-supporting cable above the area to be protected; providing a field protection system comprising a flexible membrane assembly and a plurality of foldable frame members engaged with a field-facing surface of the flexible membrane assembly; deploying the flexible membrane assembly over the protection-supporting cable; and folding the plurality of foldable frame members for first and second opposed ground-securing end portions thereof to be engaged with a ground surface surrounding the area. For instance, the method according to embodiments of the present disclosure may be carried out with a field protection system as the ones described above. The field protection systems are thus shaped and dimensioned to form a field protection easily and safely deployable while ensuring a stable protection, for instance during winter season. The field protection system can thus form a thermally insulating protection chamber over the field area or an insect-excluding chamber when used with an insect net, for instance during the growing season.

Flexible Membrane Assembly with Fluid-Receiving Ballast System

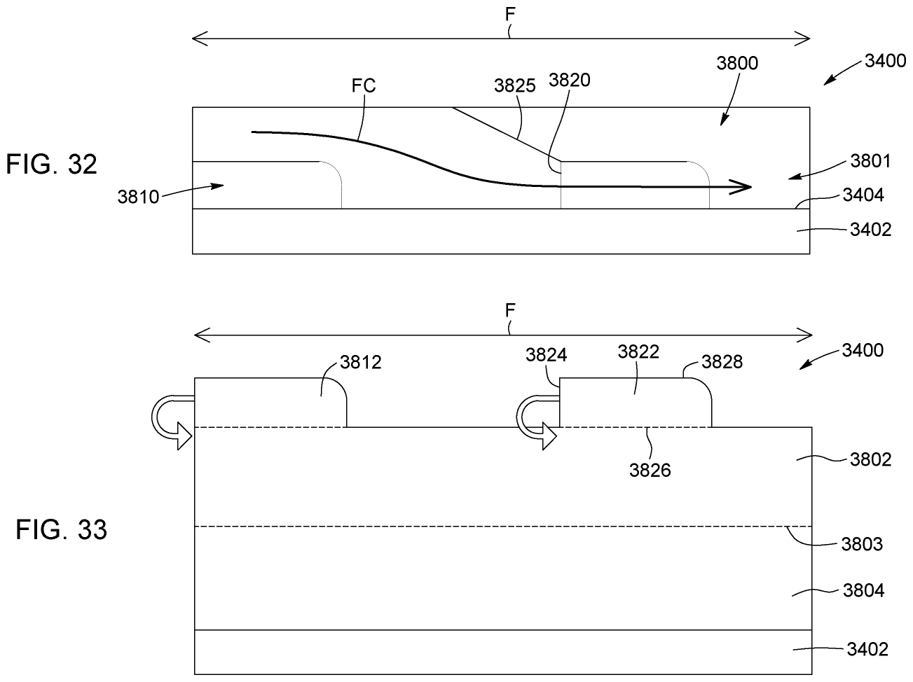

Referring now to FIGS. 32 and 33, there is shown a flexible membrane assembly 3400 comprising a flexible membrane 3402 having first and second longitudinal borders 3404 and at least one fluid-receiving ballast system 3800 secured to or formed integral with one of the first and second longitudinal borders of the flexible membrane 3402. In the embodiment shown, the fluid-receiving ballast system 3800 defines a fluid-receiving channel 3801 extending along the flexible membrane longitudinal direction F of the flexible membrane 3402 and comprising a plurality of unidirectional valves 3810, 3820 spaced-apart from each other along the longitudinal direction F of the flexible membrane 3402. The fluid-receiving ballast system 3800 is shaped and dimensioned so that a fluid (for instance water) introduced in the fluid-receiving channel 3801 via a fluid inlet (not represented) and circulating within the fluid-receiving channel 3801 in the fluid circulation direction FC (FIG. 32) is at least partially maintained in the fluid-receiving channel 3801. For instance, when the flexible membrane assembly 3400 is deployed onto a slope, the fluid inlet is arranged at a downstream portion thereof. Upon introduction of the fluid via the fluid inlet, the fluid circulates in the fluid-receiving channel 3801 in the fluid circulation direction FC opposed to the slope of the protected area. Thus, when the introduction of the fluid in the fluid-receiving channel is stopped, the fluid circulating in the fluid-receiving channel in a direction opposed to the fluid circulation direction FC due to gravity is prevented from escaping the fluid inlet. A weight of the fluid provided in the fluid-receiving channel contributes to maintaining the flexible membrane assembly over the protected area. In other words, the fluid-receiving channel being at least partially filled with the field contributes to maintaining the flexible membrane assembly onto the ground surface. The fluid-receiving ballast system 3800 further comprises a fluid outlet (not represented) formed for instance at a longitudinal portion of the fluid-receiving ballast system opposed to the fluid inlet. When the fluid outlet is in an open configuration, the fluid can thus be easily removed from the fluid-receiving channel, for instance via rolling up the flexible membrane assembly 3400 starting from the fluid inlet (from the downstream portion when the flexible membrane assembly is arranged onto the above-mentioned slope). In the embodiment shown, and as represented for instance in FIG. 33 wherein the fluid-receiving ballast system is in an unfolded state, the fluid-receiving ballast system 3800 comprises distal and proximal longitudinal portions 3802, 3804, considered with respect to the flexible membrane 3402, a longitudinal folding line 3803 being formed at a junction of the distal and proximal longitudinal portions 3802, 3804. The fluid-receiving ballast system 3800 further comprises a plurality of valve-forming flaps 3812, 3822 spaced-apart from each other along the flexible membrane longitudinal direction F of the flexible membrane 3402, secured to the longitudinal distal portion 3802 and arranged between the longitudinal distal and proximal portions 3802, 3804 when folding the distal and proximal portions onto each other along the longitudinal folding line 3803. In the embodiment shown, the valve-forming flap 3822 is substantially rectangular and comprises a bottom portion 3824 (or downstream portion) and first and second lateral sides 3826, 3828 (or proximal and distal lateral sides 3826, 3828, considered with respect to the flexible membrane 3402 to the longitudinal border of which the fluid-receiving ballast system 3800 is secured). For instance, the proximal lateral side 3826 and the bottom portion 3824 of the valve-forming flap 3822 are secured (for instance welded or thermo-welded) to the distal portion 3802. Once the distal and proximal portions 3802, 3804 are folded onto each other along the longitudinal folding line 3803, a partially closing line 3825 is formed (for instance via welding or thermo welding) to secure the distal lateral side 3828 of the flap 3822 to the distal and proximal portions 3802, 3804 and to secure the distal and proximal portions 3802, 3804 to each other between the downstream portion 3824 of the flap 3822 and the longitudinal folding line 3803. The fluid circulating in the fluid-receiving channel 3801 in the fluid circulation direction CF is thus directed in the space at least partially delimited by the valve-forming flap and an inner face of the proximal portion 3804. When the fluid circulates in the channel in the direction opposed to the fluid circulation direction CF, the fluid is trapped in the space at least partially delimited by the flap 3822 and an inner face of the distal portion 3802; the flap 3822 is thus deformed and contacts at least partially the inner face of the proximal portion 3804, thus closing at least partially the fluid-receiving channel 3801. It is understood the present disclosure is not limited to unidirectional valves comprising flaps arranged between and partially secured to longitudinal distal and proximal portions of the fluid-receiving ballast system.

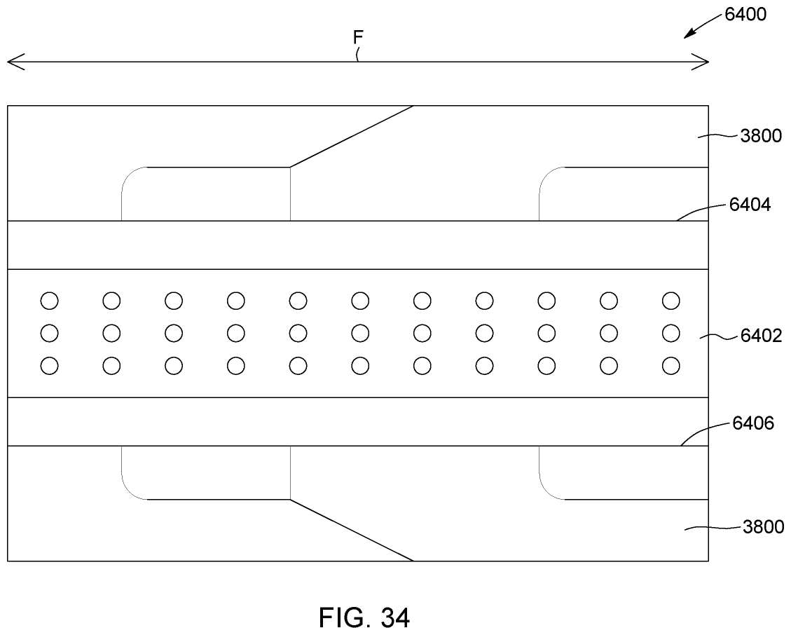

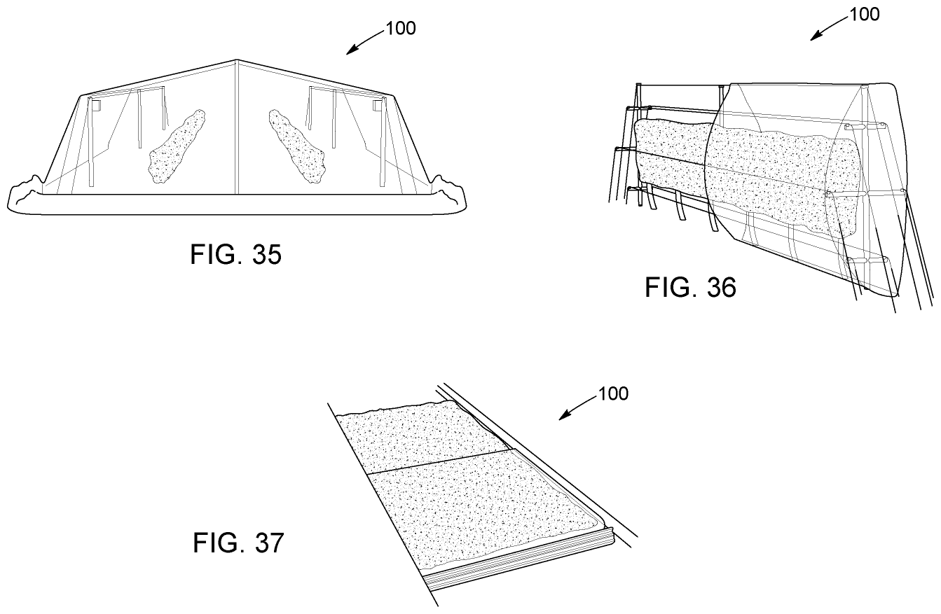

The fluid-receiving ballast system can be secured to or formed integral with longitudinal borders of a flexible membrane assembly according to any of the above-described field protection systems (see for instance FIG. 18). It could also be conceived a flexible membrane assembly 6400 as represented in FIG. 34, wherein the flexible membrane assembly 6400 comprises a flexible membrane 6402 (for instance at least partially made of perforated plastics) shaped and dimensioned to at least partially form a mulch over an area to be protected, and first and second fluid-receiving ballast systems 3800 secured to first and second longitudinal borders 6404, 6406 of the flexible membrane 6402. It is understood that all or part of the different features of the different above-described embodiments of the field protection systems could be combined together. For instance, as represented in FIG. 35, it could be conceived a field protection system 100 shaped and dimensioned to cover a field area, the field protection system comprising two fluid-receiving ballast systems secured respectively to first and second longitudinal borders of a flexible membrane. A flexible membrane assembly comprising the flexible membrane could further comprise a plurality of flexible membrane-deploying clips mounted to the flexible membrane and engageable with guide wires extending substantially parallel to each other, for instance at different heights with respect to the ground surface. As represented in FIG. 36, it could also be conceived a field protection system 100 shaped and dimensioned to cover a field area, for instance a range of trees, the field protection system comprising a flexible membrane and a plurality of flexible membrane-deploying clips mounted to the flexible membrane and engageable with guide wires extending substantially parallel to each other, for instance at different heights with respect to the ground surface. For instance, the field protection system comprises a plurality of vertical posts supporting a central one of the guide wires. For instance, a plurality of transversal members are secured to each vertical post in order to maintain spaced from each other opposed portions of the flexible membrane on each side of the central guide wire. In another embodiment, as represented for instance in FIG. 37, the field protection system 100 comprises a flexible membrane assembly comprising first and second fluid-receiving ballast systems and a flexible membrane, the first and second fluid-receiving ballast systems being secured to longitudinal borders of the flexible membrane. For instance, the flexible membrane comprises a perforated membrane, for instance to protect orchids or any other protectable plant or vegetable. The flexible membrane assembly might further comprise a plurality of membrane-deploying clips mounted to the flexible membrane and engageable with guide wires extending substantially parallel to each other, for instance close to the ground surface.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A membrane-deploying clip for a membrane assembly of a field protection system, the membrane-deploying clip comprising:
a clip body comprising:
a membrane-mounting portion; and
a wire-sliding portion with a wire-receiving slot formed therein and extending along a clip longitudinal direction; and
a mobile locking member mounted to the clip body and configurable into a wire-engaging configuration wherein a guide wire is insertable into the wire-receiving slot, and a wire-sliding configuration wherein, considered in a direction transversal to the clip longitudinal direction, the mobile locking member substantially closes the wire-receiving slot to maintain the guide wire into the wire-receiving slot while sliding therein.

2. (canceled)

3. The membrane-deploying clip according to claim 1, wherein the clip body has a membrane-mounting side, an opposed ground-facing side and first and second longitudinal sides between the membrane-mounting side and the ground-facing side, the wire-receiving slot opening into one of the ground-facing side and the first and second longitudinal sides.

4. The membrane-deploying clip according to claim 1, wherein the clip body comprises first and second clip arms spaced apart from each other and forming together at least partially the wire-sliding portion, the mobile locking member being arranged between the first and second clip arms, and wherein wire-engaging openings are formed in the first and second clip arms which form at least partially the wire-receiving slot, wherein the first and second clip arms converge toward each other at their respective wire-engaging openings.

5. (canceled)

6. The membrane-deploying clip according to claim 1, wherein, considered in a plane transversal to the clip longitudinal direction, a cross-section of the wire-sliding portion diverges away from the membrane-mounting portion.

7. The membrane-deploying clip according to claim 1, wherein the wire-sliding portion has, considered with respect with the membrane assembly, a proximal longitudinal side and a distal longitudinal side, and considered in a plane comprising the clip longitudinal direction and substantially parallel to a membrane-mounting surface of the membrane-mounting portion, a cross-section of the wire-sliding portion converges towards the distal longitudinal side.

8. The membrane-deploying clip according to claim 1, wherein the mobile locking member is pivotally mounted to the clip body and comprises a hooking portion having a peripheral wall at least partially delimiting a wire-receiving aperture substantially in register with the wire-receiving slot formed in the clip body, the wire-receiving aperture forming a wire-engaging opening in the peripheral wall of the hooking portion and wherein the mobile locking member is shaped and dimensioned to be automatically configured into the wire-sliding configuration.

9-19. (canceled)

20. A field protection system to form a protective canopy over a field, comprising:
a membrane assembly comprising a membrane and a plurality of membrane-deploying clips according to claim 1 mounted to or formed integral with the membrane;
a plurality of guide wire-mounting post heads mountable to a plurality of posts to extend above the field to be protected, at least one of said plurality of guide wire-mounting post heads comprising:
a post head body mountable to the corresponding post to extend above the field and having a wire-mounting slot formed therein and extending along a head longitudinal direction,
a mobile latch mounted to the post head body; and
a guide wire at least partially receivable into the wire-mounting slots of the plurality of guide wire-mounting post heads to extend above the field to be protected;
wherein the mobile latch of said at least one of said plurality of guide wire-mounting post heads is configurable into an open configuration wherein the guide wire is insertable into the wire-mounting slot, and a closed configuration wherein, considered in a direction transversal to the head longitudinal direction, the mobile latch substantially closes the wire-mounting slot to maintain the guide wire into the wire-mounting slot.

21. (canceled)

22. The field protection system according to claim 20 or 21, further comprising a membrane-deploying system comprising at least first and second toothed pulleys rotatably mountable at opposed end portions of the field, the membrane-deploying system further comprising a deploying belt extending from the first toothed pulley to the second toothed pulley, at least partially surrounding the first and second toothed pulleys and arranged in the vicinity of the plurality of guide wire-mounting post heads when installed, wherein each of the first and second toothed pulleys comprises an inner core and a plurality of teeth extending outwardly from the inner core and regularly spaced apart from each other along an outer periphery of the inner core, a plurality of clip-receiving gaps being formed between adjacent teeth which are shaped and dimensioned to receive each one of the plurality of membrane-deploying clips.

23. (canceled)

24. The field protection system according to claim 20, further comprising a clip-mounting assembly with at least one clip-guiding slot formed therein extending along a clip-mounting longitudinal direction, the wire-sliding portions of the plurality of membrane-deploying clips being shaped and dimensioned to be received and slide within the clip-guiding slot, wherein the clip-guiding slot is dividable, considered along the clip-mounting longitudinal direction, into at least two clip-engaging portions spaced apart from each other, a clip-mounting portion and a clip outlet, said at least two clip-engaging portions converging towards each other at the clip-mounting portion.

25. (canceled)

26. The field protection system according to claim 20, wherein the membrane has at least one longitudinal border and wherein the membrane assembly further comprises a fluid-receiving ballast system secured to or formed integral with said at least one longitudinal border, said fluid-receiving ballast system defining a fluid-receiving channel extending along a length of the membrane and comprising a plurality of unidirectional valves spaced-apart from each other along the length.

27. (canceled)

28. A field protection system to form a protection over a field, comprising:
a membrane assembly comprising a membrane having a field-facing surface; and
a plurality of foldable frame members at least partially engaged with the field-facing surface of the membrane, each of said plurality of foldable frame members comprising first and second frame legs each comprising a ground-securing end portion and an opposed connecting portion, the first and second frame legs being connected to each other via their respective connecting portions;
wherein each of said plurality of foldable frame members is configurable into a storage configuration wherein the first and second frame legs are substantially aligned with each other, and into a protection configuration, wherein the first and second frame legs are inclined with respect with each other with the connecting portions thereof forming an apex of the corresponding foldable frame member.

29. (canceled)

30. The field protection system according to claim 28, wherein the membrane is at least partially formed of at least one of a geotextile membrane, a net, a plastic film, fabrics or a canvas.

31. The field protection system according to claim 28, wherein each of the first and second frame legs of said plurality of foldable frame members comprises a leg body, the corresponding ground-securing end portion comprising a pivotable spike pivotally mounted to the corresponding leg body.

32. The field protection system according to claim 28, further comprising first and second guide wires, the ground-securing end portions of the first and second frame legs of the plurality of foldable frame members being engageable respectively with the first and second guide wires.

33. The field protection system according to claim 32, wherein at least one ground-securing end portion of the first and second frame legs of at least one of the plurality of foldable frame members comprises a cable-engaging hook, and the cable-engaging hook defines a closable cable-receiving cavity and wherein said at least one ground-securing end portion comprises a locking member configurable into an installation configuration wherein one of the first and second guide wires is engageable with the cable-receiving cavity, and into a protection configuration, wherein said one of the first and second guide wires is retained within the cable-receiving cavity.

34. (canceled)

35. The field protection system according to claim 28, further comprising at least one deployable base assembly comprising a pole-mounting base and first and second cable-engaging arms pivotally mounted to the pole-mounting base and each comprising a cable-engaging end portion, the deployable base assembly being configurable into at least a retracted configuration wherein the cable-engaging end portions of the first and second cable-engaging arms are proximate each other, and into a deployed configuration, wherein the first and second cable-engaging arms extend in opposed directions away from the pole-mounting base, thereby forming therebetween a deployment angle.

36. The field protection system according to claim 35, wherein said at least one deployable base assembly further comprises a locking system, to lock said at least one deployable base assembly into at least one of the retracted and deployed configurations wherein each of the first and second cable-engaging arms comprises a toothed disk, each of the toothed disks comprising an indented surface, the indented surfaces of the toothed disks facing each other and wherein said at least one deployable base assembly is configurable into a plurality of deployed configurations defining a plurality of deployment angles between the first and second cable-engaging arms upon pivoting of the toothed disks of the first and second cable-engaging arms about a common rotation axis.

37. (canceled)

38. (canceled)

39. The field protection system according to claim 28, wherein the membrane has at least one longitudinal border and wherein the membrane assembly further comprises a fluid-receiving ballast system secured to or formed integral with said at least one longitudinal border, said fluid-receiving ballast system defining a fluid-receiving channel extending along a length of the membrane and comprising a plurality of unidirectional valves spaced-apart from each other along the length.

40. A method for forming a protection over a field, the method comprising:
arranging a protection-supporting cable above said field;
providing a field protection system comprising a membrane assembly and a plurality of foldable frame members engaged with a field-facing surface of the membrane assembly;
deploying the membrane assembly over the protection-supporting cable; and
folding the plurality of foldable frame members for first and second opposed ground-securing end portions thereof to be engaged with a ground surface surrounding said field.

41. The method according to claim 40, further comprising:
arranging first and second guide wires extending along first and second longitudinal borders of the field; and
engaging the first and second ground-securing end portions of the plurality of foldable frame members respectively with the first and second guide wires.
